(19) United States
(12) Patent Application Publication
(10) Pub. No.: US 2024/0107602 A1
(43) Pub. Date: Mar. 28, 2024

(54) METHODS, ARCHITECTURES, APPARATUSES AND SYSTEMS FOR SERVICE CONTINUITY FOR PREMISES NETWORKS

(71) Applicant: INTERDIGITAL PATENT HOLDINGS, INC., Wilmington, DE (US)

(72) Inventors: FILIPE CONCEICAO, London (GB); Alain MOURAD, Ascot (GB); Ulises OLVERA-HERNANDEZ, Saint-Lazare (CA)

(21) Appl. No.: 18/035,049

(22) PCT Filed: Nov. 3, 2021
(86) PCT No.: PCT/US2021/057965

§ 371 Date: May 2, 2023

Related U.S. Application Data
(60) Provisional application No. 63/109,022, filed on Nov. 3, 2020.

(51) Int. Cl. H04W 76/15; H04W 28/08; H04W 72/25

(52) U.S. Cl. CPC H04W 76/15; H04W 28/0967; H04W 72/25; H04W 88/16

(57) ABSTRACT

Procedures, methods, architectures, apparatuses, systems, devices, and computer program products for maintaining service continuity in 5G telecommunication networks for wireless transmit/receive units (WTRUs) when the WTRUs switch between various connectivity scenarios, e.g., switching from direct connectivity between two WTRUs to connectivity between the two WTRUs via a gateway, are described.

### CROSS-REFERENCE TO RELATED APPLICATIONS

This application claims the benefit of U.S. Provisional Patent Application No. 63/109,022 filed 3-Nov-2020; which is incorporated herein by reference. This application is related to U.S. Provisional Patent Application No. 62/967,505, filed 29-Jan-2020, and is incorporated herein by reference.

### BACKGROUND

This application is generally directed to the fields of communications, software and encoding, including, for example, to methods, architectures, apparatuses, systems directed to service continuity in connection with residential networks. For example, disclosures herein are directed to maintaining service continuity for wireless transmit/receive units (WTRUs) in 5G telecommunication networks when switching between various residential network connectivity scenarios, e.g., switching from direct connectivity (e.g., direct device-to-device connectivity) between two WTRUs to connectivity between the two WTRUs through infrastructure equipment, such as, e.g., a 5G residential gateway.

### BRIEF DESCRIPTION OF THE DRAWINGS

A more detailed understanding may be had from the detailed description below, given by way of example in conjunction with the drawings appended hereto. Figures in such drawings, like the detailed description, are examples. As such, the Figures and the detailed description are not to be considered limiting, and other equally effective examples are possible and likely. Furthermore, like reference numerals (“ref.”) in the Figures (“FIGs.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 1E is a block diagram illustrating various example elements of the example communications system;

FIG. 1F is a block diagram illustrating an example architecture of the example communications system;

FIG. 1G is a block diagram illustrating various example elements of the example communications system;

FIG. 1H is a block diagram illustrating various example elements of the example communications system;

FIG. 2A illustrates an example user plane for a PC5 interface (PC5-U);

FIG. 2B illustrates an example discovery plane PC5 interface (PC5-D);

FIG. 2C illustrates an example PC5 signaling protocol stack;

FIG. 2D illustrates granularity of a plurality of PC5 unicast links;

FIG. 2E is a block diagram illustrating an example mapping of a per-flow QoS model for a PC5 interface;

FIG. 3 is a block diagram illustrating an example architecture of a WTRU according to an embodiment;

FIG. 4 is a block diagram illustrating a first mobility/connectivity switching scenario and/or use case;

FIG. 5 is a block diagram illustrating a second mobility/connectivity switching scenario and/or use case;

FIG. 6 is a diagram illustrating an example message exchange in connection with carrying out service continuity according to various embodiments;

FIG. 7 illustrates an example non-access stratum (NAS) message; and

FIG. 8 is a flow chart illustrating an example flow for carrying out service continuity according to various embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

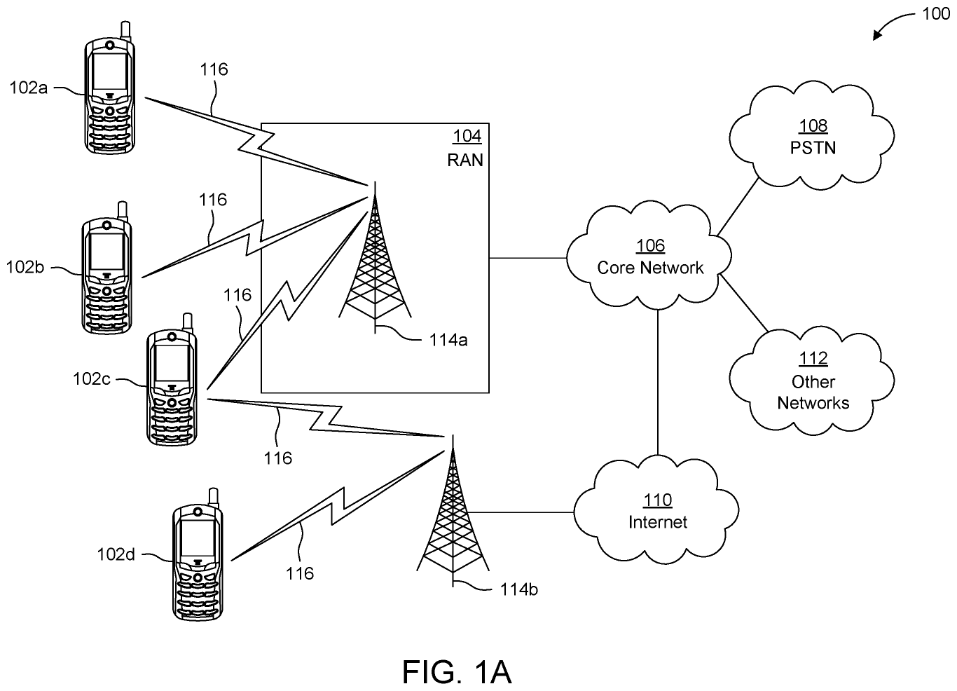

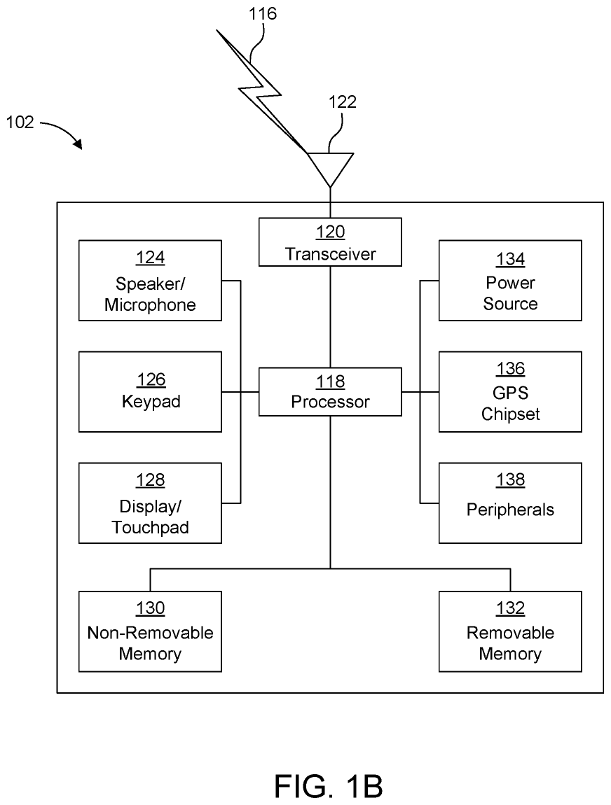

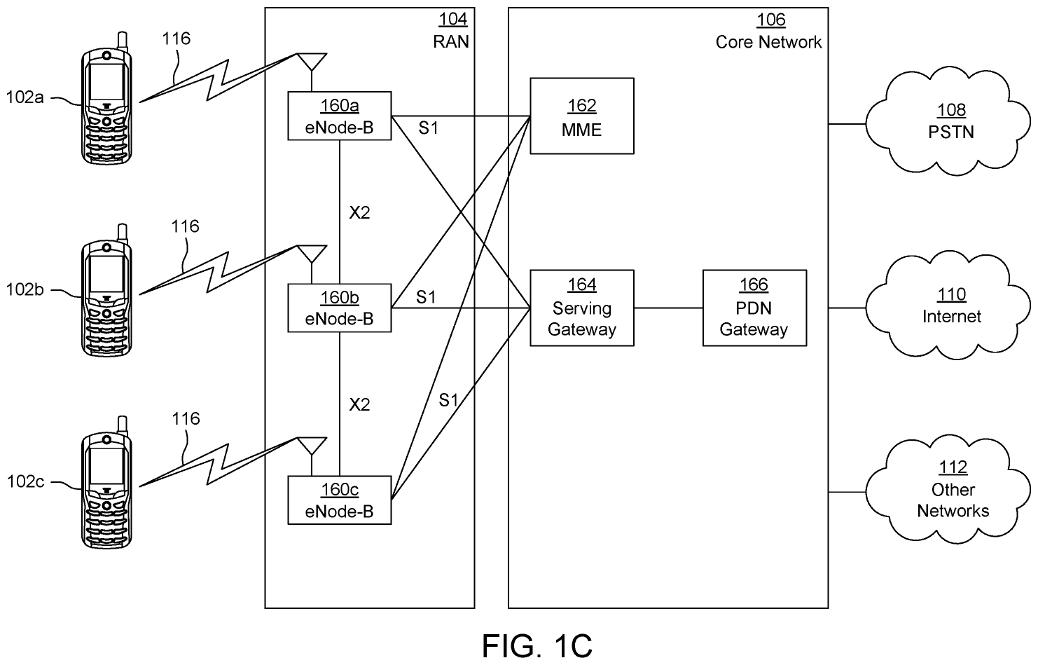

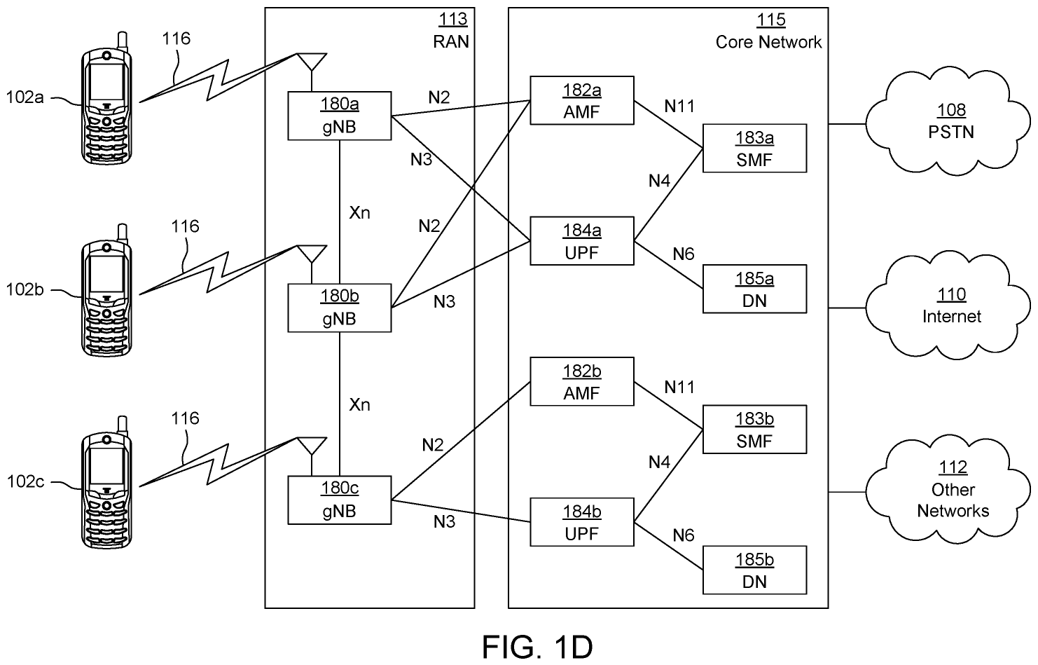

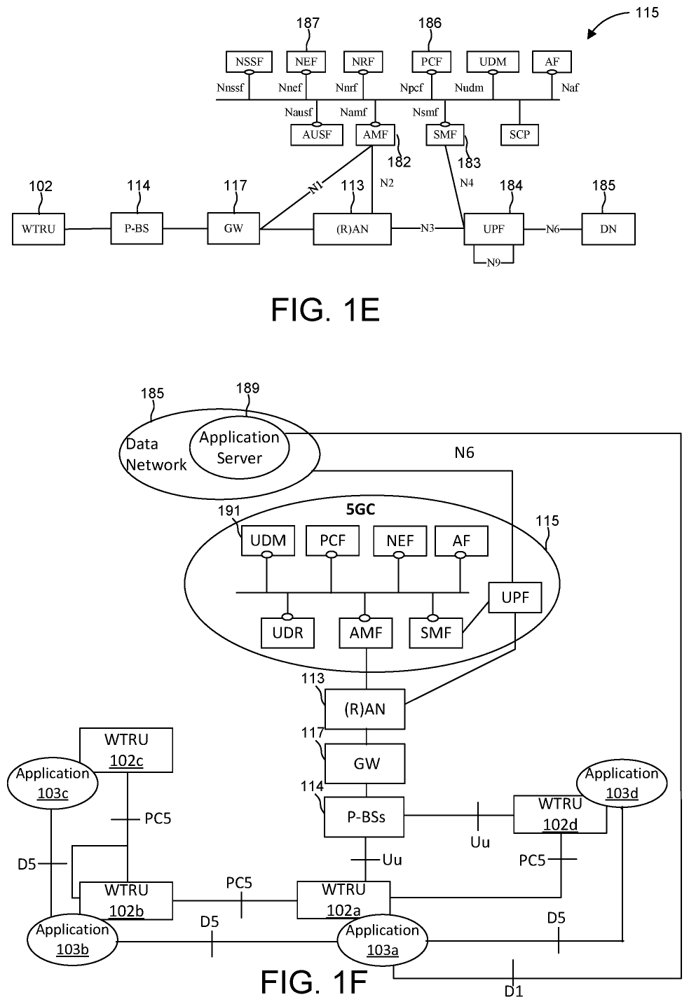

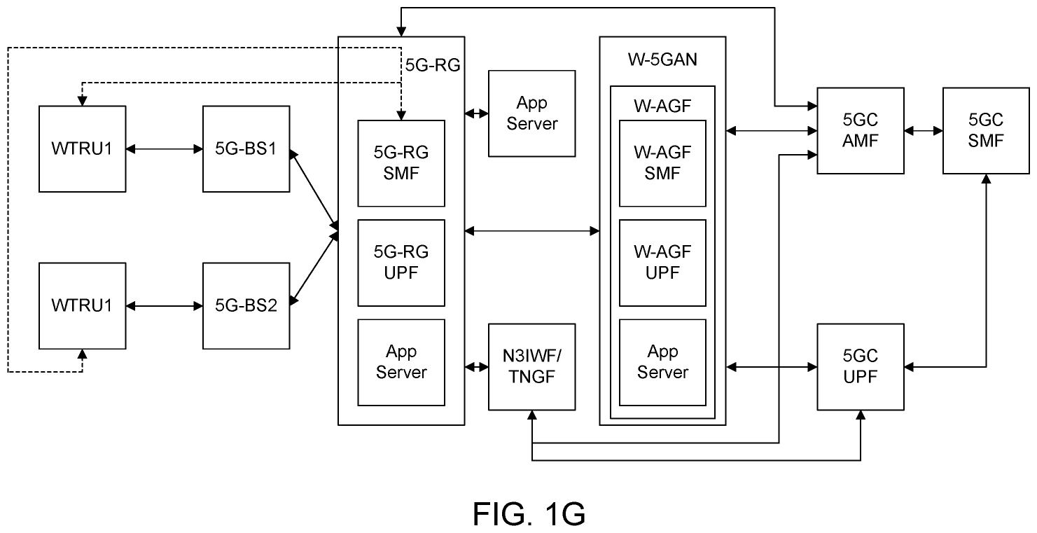

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

FIG.1E is a block diagram illustrating various example elements of the communications system 100. Such elements may be included, for example, in embodiments of the communications system 100 in which such system is configured in accordance with 5G and/or NR. The elements may include one or more WTRUs 102, one or more premises BSs (collectively “premises BSs 114”), one or more gateways (collectively “gateways 117”), one or more (R)ANs 113, one or more DNs 185 and elements of a core network 115, including an AMF 182, an SMF 183, a UPF 184, a policy control function (PCF) 186, and a network exposure function (NEF) 187. For convenience and simplicity of exposition, the terms “5G core network” and “5GC” may be used interchangeably with CN 115.

The AMF 182 may carry out various functions, including, for example, any of the following: termination of a RAN CP interface (N2), termination of NAS (N1), NAS ciphering and integrity protection, registration management, connection management, reachability management, mobility management, lawful intercept, etc. The SMF 183 may carry out various functions, including, for example, any of the following: session management (including session establishment, modification and release), IP address allocation, selection and control of user plane function(s), etc. The PCF 186 may carry out various functions, including, for example, any of the following: providing support for a unified policy framework to govern network behavior, providing policy rules to one or more control plane functions to enforce them, etc. The NEF 187 may carry out various functions, including, for example, any of the following: exposing capabilities and events, secure provisioning of information from external application to the network, etc. The UPF 184 may carry out various functions, including, for example, any of the following: operating as an anchor point for intra-/inter-RAT mobility, allocation of UE IP address, external PDU Session point of interconnect to a DN, such as DN 185, packet routing and forwarding, packet inspection, etc. The (R)ANs 113 may connect to a CN, which, for example, may be configured as a 5G core network. The (R)ANs 113 may be configured as any of a NG-RAN and a non-3GPP (R)AN. Any of the (R)ANs 113 may be configured, for example, as any of a wireline 5G access network (W-5GAN), an untrusted non-3GPP access network and a trusted non-3GPP access network.

The gateways 117 may communicatively couple with (i) the (R)ANs 113, e.g., using respective one or more (e.g., a set of one or more) first interfaces and/or first protocol stacks, and (ii) the premises BSs 114, e.g., using one respective one or more (e.g., a set of one or more) second interfaces and/or second protocol stacks. Transmissions exchanged via the gateways 117 may include any of (i) transmissions originated from one or more of the WTRUs 102 towards one or more of the DNs 185 and/or one or more of the other WTRUs 102 via the premises BSs 114, and (ii) transmissions terminated to the WTRUs 102 via the premises BSs 114.

The premises BSs 114 may be disposed and/or deployed within (at) one or more premises (e.g., residences, offices, campuses, etc.) and may communicatively couple with the gateways 117, e.g., using respective one or more (e.g., a set of one or more) third interfaces and/or protocol stacks. The third interfaces and/or protocol stacks may correspond to the second interfaces and/or protocol stacks. In an embodiment, the premises BSs 114 disposed/deployed within (at) a single premises (e.g., a residence, an office, a campus, etc.) may be networked, e.g., using any of various networking protocols.

A single gateway 117 may be associated with all of the premises BSs 114 disposed/deployed within (at) a single premises. Alternatively, more than one gateway 117 may be associated with the premises BSs 114 disposed/deployed within (at) a single premises (e.g., all or some of the premises BSs 114 disposed/deployed within (at) a single premises may be associated with each of a plurality of the gateways 117). Any of the gateways 117 may, but need not, be disposed/deployed within (at) the premises at which associated premises BSs 114 are disposed/deployed.

FIG. 1F is a block diagram illustrating an example architecture of the communications system 100 configured in accordance with 5G and/or NR. For convenience and simplicity of exposition, the terms “5G System” and its abbreviation “5GS” may be used herein to refer to the communications system 100 configured in accordance with 5G and/or NR. The example architecture shown in FIG. 1F may be suitable for various services in 5GS, including any of proximity-based services (ProSe), vehicle-to-everything (V2X) services, other device-to-device (D2D) communication services, and residential premises services. The example architecture may include WTRUs 102a-d, one or more premises BSs 114, one or more gateways 117, one or more (R)ANs 113, a DN 185 and a 5GC 115.

The WTRUs 102a-d may include respective applications (“WTRU applications”) 103a-d. The WTRU applications 103a-d (e.g., each of the WTRU applications 103a-d) may be, for example, any of a ProSe application, a V2X application and other like-type applications. The DN 185 may include an application server 189. The application server 189 may include one or more applications that service any of the WTRU applications 103a-d.

D1 is a reference point between a WTRU application 103 and an application in the application server 189. D5 is a reference point between the WTRU applications 103 (e.g., between and/or among two or more WTRU applications 103a-d of the WTRUs 102a-d). PC5 is a D2D interface for direct D2D communications between and/or among two or more of the WTRUs 102a-d. The PC5 interface may be configured, for example, as any of an LTE-based PC5, NR-based PC5 and the like. The terms PC5 interface and “sidelink” (at the PHY layer) may be referred to herein interchangeably.

FIG. 1G is a block diagram illustrating various example elements of the communications system 100. Such elements may be included, for example, in embodiments of the communications system 100 in which such system is configured in accordance with 5G and/or NR. The elements may include first and second WTRUs 102a, 102b, first and second premises BSs 114a, 114b, a gateway 117, a plurality of (R)ANs, an application server 189, and elements of a core network 115, including an AMF 182, an SMF 183 and a UPF 184. The plurality of (R)ANs 113 may include a NG-RAN (not shown), a W-SGAN 113a, a trusted non-3GPP access network 113b and an untrusted non-3GPP access network 113c. The W-5GAN may include a wireline access gateway function (W-AGF) 119. The trusted non-3GPP access network 113b may include a trusted non-3gpp gateway function (TNGF) 121. The trusted non-3GPP access network 113c may include a non-3GPP interworking function (N3IWF) 123. Although not shown, the elements may include more or fewer than two WTRUs, more or fewer that two premises BSs, more than one gateway, more or fewer (R)ANs, more than one TNGF, more than one N3IWF, and more than one of each of the elements of the core network 115.

The gateway 117 may connect to the 5GC 115 via any of the NG-RAN (not shown), the W-5GAN 113a, the N3IWF and the TNGF. The gateway 117 may include (e.g., instantiate) a local SMF (GW SMF) 125, a local UPF (GW UPF) 127 and an application server (GW application server) 129. The W-AGF 119 may include (e.g., instantiate) a local SMF (W-AGF SMF) 131, a local UPF (W-AGF UPF) 133 and an application server (W-AGF application server) 135. Although not shown, the gateway 117 and/or the W-AGF 119 may include more than one S1VIF, more than one UPF and more than one application server. In an embodiment, the W-AGF SMF 131, W-AGF UPF 133 and/or W-AGF application server 135 may be included in the W-AGF 119 if the access to the 5GC 115 for the gateway 117 is intermediated by it. In which case, the gateway 117 might not include (e.g., instantiate) a local S1VIF, a local UPF and/or an application server. In an embodiment, the gateway 117 may be part of (and/or interface with) the trusted non-3GPP access network 113b and/or the trusted non-3GPP access network 113c, and access to the AlVIF 182 and UPF 184 may be provided by the TNGF 121 and/or the N3IWF, respectively. Embodiments may be extended to these different network topologies also.

The GW SMF 125, GW UPF 127, GW application server 129, W-AGF SMF 131, W-AGF UPF 133 and W-AGF application server 135 may have and provide the same functionalities as counterparts of a public 5GC domain. They may be used by the AMF 182 to forward session management requirements in the case of the GW-SMF 125 or W-AGF SMF) 131 and consequently set the parameters that define traffic steering parameters and ensure the appropriate routing of packets on the GW UPF 127 and/or W-AGF UPF 133. It is worth noting that following the same rationale, the GW application server 129 and/or the W-AGF application server 135 may be instances of the ProSe application server 189.

If the 5G-RG is part of a trusted or untrusted non-3GPP network, then the access to the AMF and UPF may be provided by a trusted non-3gpp gateway function (TNGF) or non-3gpp interworking function (N3IWF), respectively. Embodiments may be extended to these different network topologies also.

Direct D2D communication, such as ProSe direct communication, enable establishment of communication paths between two or more of the WTRUs 102 that are within proximity/range of each other. Direct D2D discovery, such as ProSe direct discovery, may be used by a WTRU 102 to identify other WTRUs in proximity. Details for provisioning the WTRUs for direct communication and/or direct discovery and/or for both in-coverage and out-of-coverage scenarios may be found, for example, in 3GPP TS 23.303 V16.0.0.

Sidelink communication may be carried out using any of an autonomous transmission mode and a scheduled transmission mode. For example, sidelink communications may be carried out using an autonomous transmission mode for WTRUs that are out-of-coverage (CM-IDLE and RRC_IDLE). In the autonomous transmission mode, radio resources may be read from a system information block (SIB), such as SIB 18. For the WTRUs that are in-coverage (CM-CONNECTED/CM-IDLE, RRC_IDLE/RRC_CONNECTED with or without active PDU sessions), the sidelink communication may be carried out using the scheduled transmission mode or the autonomous transmission mode. Table 1 lists, for each of ProSe direct communication and ProSe direct discovery, which transmission mode is selectable based on whether the WTRU is in- or out-of-coverage. Table 1 also lists, for each of ProSe direct communication and ProSe direct discovery, whether the transmission resources are preconfigured or indicated by a RAN.

TABLE 1

| | Scheduled Transmission Mode | Autonomous Transmission Mode |
|---|---|---|
| ProSe Direct | Only in coverage. | In coverage and Out of coverage. |
| Communication | Resources for transmission | Resources pools for transmission |
| | are indicated by RAN. | are pre configured. |
| ProSe Direct | Only in coverage. | In coverage and Out of coverage. |
| Discovery | Resources for transmission | Resources pools for transmission |
| | are indicated RAN. | are pre configured. |

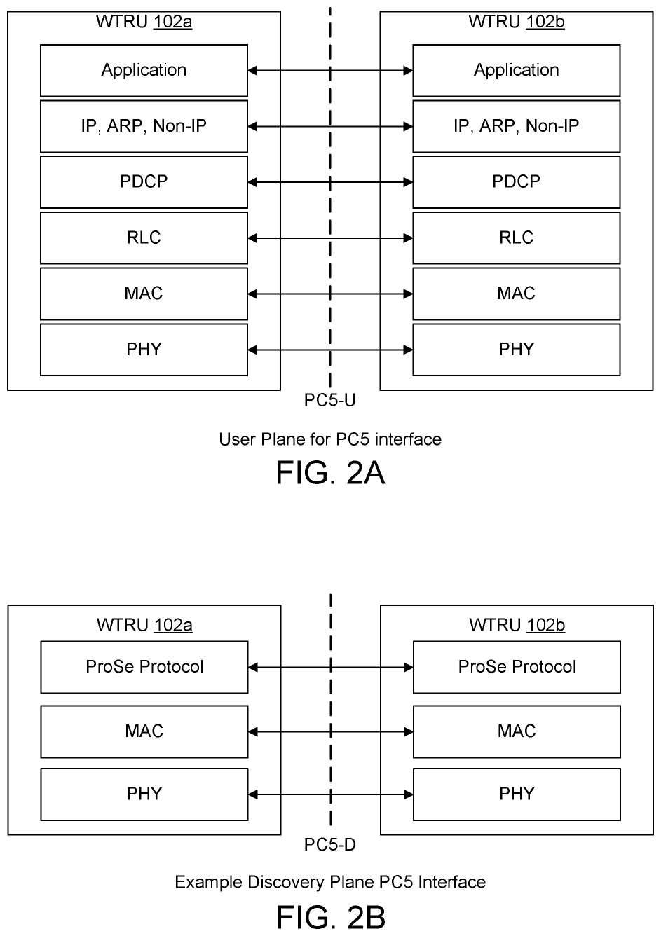

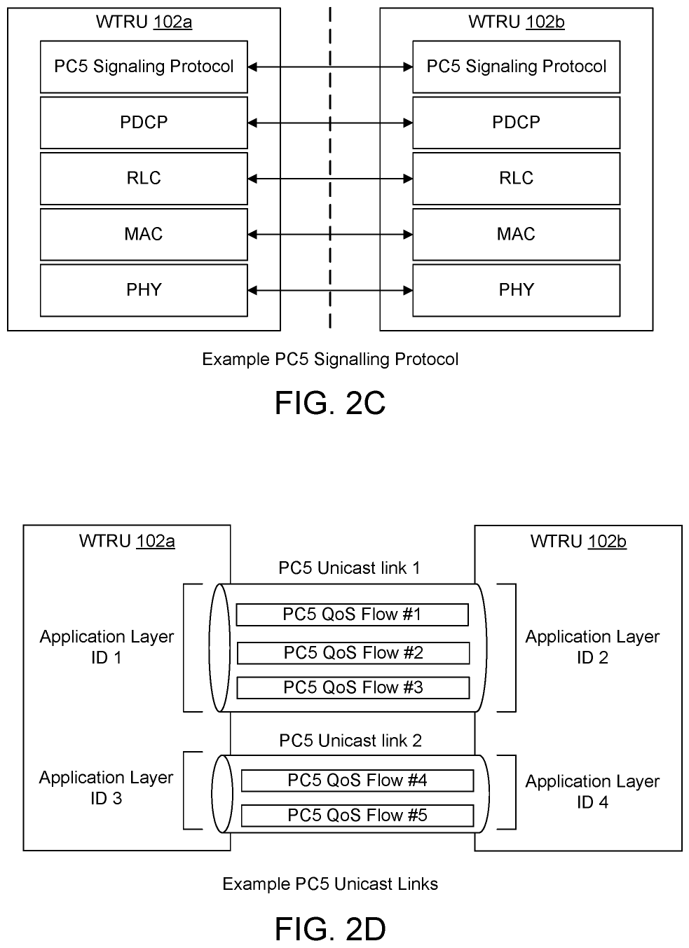

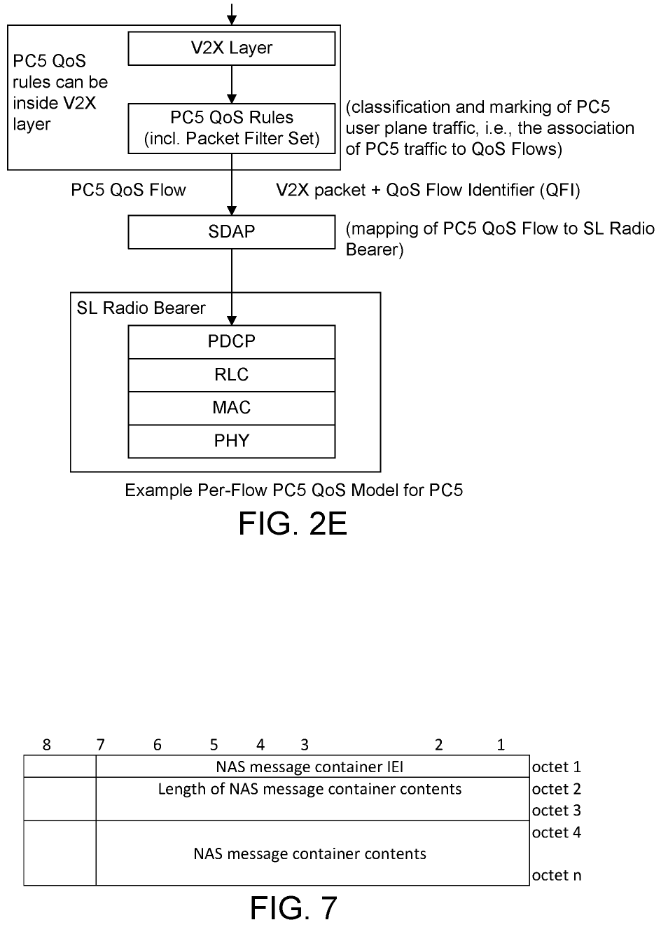

FIG. 2A illustrates an example user plane for a PC5 interface (PC5-U). Example details of the PDCP/RLC/MAC/PHY functionality may be found for example in 3GPP TS 36.300.

FIG. 2B illustrates an example discovery plane PC5 interface (PC5-D). The ProSe protocol may be used for handling ProSe direct discovery. Example detail of a PC5-D may be found for example in 3GPP TS 24.334.

FIG. 2C illustrates an example PC5 signalling protocol stack. The PC5 signalling protocol stack is used for control plane signalling over PC5, including, for example, signalling to establish, maintain and release of the secure layer-2 link over the PC5 interface, TMGI monitoring requests, Cell ID announcement requests etc. The SDU Type field (which may be 3 bits) in the PDCP header may be used to discriminate between IP, ARP and PC5 signalling protocol.

A unicast mode of communication may be supported over PC5 reference (e.g., the NR based PC5 reference point). FIG. 2D illustrates granularity of a plurality of PC5 unicast links. The granularity of a PC5 unicast link may be the same as the pair of application layer IDs for both of the WTRUs 102a-b. One PC5 unicast link may support one or more services if the services are associated with a same pair of application layer IDs. As shown, the WTRU 102a has two PC5 unicast links with a WTRU 102b. The first of the PC5 unicast links may be identified by application layer ID 2 and the second of the PC5 unicast links may be identified by application layer ID 4. One PC5 unicast link may support one or more PC5 QoS Flows for the same or different services.

When the application layer initiates a service that uses a PC5 unicast communication, the WTRU 102a may establish a PC5 unicast link with the corresponding WTRU 102b using a layer-2 link establishment procedure. During the unicast link establishment, each of the WTRUs 102a-B may self-assign a PC5 link ID and may associate the self-assigned PC5 link ID with a unicast link profile for the established unicast link. The PC5 link identifier may have a unique value within the WTRU.

The unicast link profile identified by the PC5 link identifier may include any of an application layer ID of WTRU 102a, a layer-2 ID of WTRU 102a, and application layer ID of WTRU 102b, a layer-2 ID of the of WTRU 102b and a set of PC5 QoS flow identifiers (PFIs). Each PFI may be associated with one or more QoS parameters. FIG. 2E is a block diagram illustrating an example mapping of a per-flow QoS model for a PC5 interface, such as, for example, a NR PC5 interface.

The PC5 link identifier and PFIs remain unchanged for an established unicast link regardless of any changes of any of the application layer IDs and the layer-2 IDs. A beneficial consequence of the PFIs remaining unchanged is that an access stratum (AS) layer of a WTRU may identify a PC5 QoS flow based on (e.g., solely based on) a corresponding PFI provided to it. The AS layer, for example, need not rely on any of the source and destination layer-2 IDs (and, in turn, need not track any changes thereto) to identify a PC5 QoS flow.

The PC5 link identifier may be used to indicate the PC5 unicast link to the application layer. The application layer may identify the PC5 unicast link based on (e.g., solely based on) the PC5 link identifier provided to it. The PC5 link identifier may be (at least locally) unique to allow the application layer to identify a corresponding PC5 unicast link from among a plurality of unicast links associated with one service type (e.g., if one WTRU establishes a plurality of unicast links with one or more other WTRUs for a same service type).

Current mechanisms for maintaining service continuity for applications running over a PC5 communication path are not optimized for the likely occurrence of WTRUs not remaining within proximity/range of each other to continue device-to-device (D2D) communications. The current PC5 signalling protocol provides keep alive functionality. The WTRUs use this functionality to, among other things, detect whether the PC5 side link is or remains (or, conversely, is not or is no longer) viable for communications between WTRUs. If a WTRU detects that the PC5 side link is not or is no longer viable for communications (e.g., due to timeout), then an implicit layer-2 link release procedure over PC5 is carried out. The implicit layer-2 link release procedure is as follows:
one WTRU (“WTRU 102a”) sends a disconnect request message to the other WTRU (“WTRU 102b”);

WTRU 102a deletes all context data associated with the layer-2 link;

After reception of the disconnect request message, WTRU 102b sends to WTRU 102a a disconnect response message (e.g., as an acknowledgement); and

WTRU 102b deletes all context data associated with the layer-2 link.

A consequence of carrying out the implicit layer-2 link release procedure is that user plane applications and corresponding PC5 flows running over the PC5 side link are inevitably interrupted and eventually terminate. Another consequence of carrying out the implicit layer-2 link release procedure is that, because non-routable layer-2 addresses are used for PC5 flows, once the layer-2 link is released the WTRUs lack routable addresses on which to forward ProSe packets.

Service continuity is possible with existing 3GPP mechanisms. However, the existing 3GPP mechanisms require many messages exchanges—no less 33 message exchanges.

As would be appreciated by a person of skill in the art based on the teachings herein, encompassed within the embodiments described herein, without limitation, are procedures, methods, architectures, apparatuses, systems, devices, and computer program products directed to improved service continuity in connection with a likely occurrence of WTRUs not remaining within proximity/range of each other to continue device-to-device (D2D) communications.

Among the procedures, methods, architectures, apparatuses, systems, devices, and computer program products is a first method that may be implemented in network element of a core network of a communications system and that may include any of: receiving, from one or both of first and second WTRUs via at least one gateway associated with a premises, one or more first transmissions comprising first information indicating first and second IDs associated to the first and second WTRUs in connection with a sidelink; receiving, from the first WTRU via the at least one gateway, a second transmission comprising second information indicating a first request to establish a first PDU session, a first PDU session ID and a description of a traffic flow associated with the sidelink; receiving, from the second WTRU via the at least one gateway, a third transmission comprising third information indicating a second request to establish a second PDU session, a second PDU session ID and the description of the traffic flow associated with the sidelink; and transmitting a fourth transmission comprising fourth information indicating (i) an instruction to configure the at least one gateway with at least one SMG and (ii) to trigger the at least one SMF to establish the first and second PDU sessions via the at least one gateway based on/using the first and second PDU session IDs indicated by the second and third transmissions and the description of a traffic flow associated with the sidelink indicated by at least one of the second and third transmissions.

The first method may include determining to use the at least one session management function for the first and second PDU sessions based on at least one of the first request to establish the first PDU session and the second request to establish the second PDU session being received via the at least one gateway.

In an embodiment, the first transmissions may be a service request message, and the service request message may include the first information. In an embodiment, the second transmission may include a first PDU session establishment request message, and the first PDU session establishment request message may include the second information. In an embodiment, the third transmission may include a second PDU session establishment request message, and the second PDU session establishment request message may include the third information. In an embodiment, the fourth transmission may include a PDU session request message, and the second PDU session request message may include the fourth information.

In an embodiment, the description of the traffic flow (“traffic-flow description”) associated with the sidelink may include any of a PC5 QoS flow identifier (PFI), a QoS rule and a packet filter. In an embodiment, the network element of the core network may be, or may include, an access and mobility management function (AMF).

In an embodiment, the first identifier may include any of an application layer identifier and a layer-2 identifier associated to the first WTRU in connection with a sidelink. In an embodiment, the second identifier may include any of an application layer identifier and a layer-2 identifier associated to the second WTRU in connection with a sidelink.

In an embodiment, the first PDU session may be based on any of a first application layer identifier and a first layer-2 identifier associated to the first WTRU in connection with a sidelink. In an embodiment, the second PDU session ID may be based on any of a second application layer identifier and a second layer-2 identifier associated to the second WTRU in connection with a sidelink.

In an embodiment, the first information is transmitted as, or in, in a notification message. In an embodiment, the first information is transmitted as, or in, any of a non-access stratum, NAS, message and a radio resource control, RRC, message.

In an embodiment, any of the second information and the third information may include any of network slice information and a data network name (DNN). In an embodiment, the first information may include a state of a sidelink between the first WTRU and a second WTRU. In an embodiment, the state of a sidelink between may be a first of at least one value, and the first value may indicate the sidelink is not, no longer or not likely to remain viable for communications with the second WTRU.

Among the procedures, methods, architectures, apparatuses, systems, devices, and computer program products is a second method that may be implemented in in a gateway associated with a premises and that may include any of: receiving, from one or both of first and second WTRUs one or more first transmissions comprising first information indicating first and second IDs associated to the first and second WTRUs in connection with a sidelink; transmitting the one or more first transmissions to a network element of a core network of a communications system; receiving, from the first WTRU, a second transmission comprising second information indicating a first request to establish a first PDU session, a first PDU session ID and a description of a traffic flow associated with the sidelink; transmitting the second transmission to the network element; receiving, from the second WTRU, a third transmission comprising third information indicating a second request to establish a second PDU session, a second PDU session ID and the description of the traffic flow associated with the sidelink; transmitting the third transmission to the network element; receiving, from the network element, a fourth transmission comprising fourth information indicating (i) an instruction to configure the gateway with at least one session management function and (ii) to trigger the at least one session management function to establish the first and second PDU sessions via the at least one gateway based on/using the first and second PDU session IDs indicated by the second and third transmissions and the description of a traffic flow associated with the sidelink indicated by at least one of the second and third transmissions; configuring the gateway with the at least one session management function; and triggering the at least one session management function to establish the first and second PDU sessions via the at least one gateway based on/using the first and second PDU session IDs indicated by the second and third transmissions and the description of a traffic flow associated with the sidelink indicated by at least one of the second and third transmissions.

In an embodiment, the method may include any of: configuring the gateway with the at least one user plane function; and configuring the at least one user plane function based on/using the first and second PDU session IDs indicated by the second and third transmissions and the description of a traffic flow associated with the sidelink indicated by at least one of the second and third transmissions.

In an embodiment, the one or more first transmissions may include a service request message, and the service request message may include the first information. In an embodiment, the second transmission may include a first PDU session establishment request message, and wherein the first PDU session establishment request message comprises the second information.

In an embodiment, the third transmission may include a second PDU session establishment request message, and the second PDU session establishment request message may include the third information. In an embodiment, the fourth transmission may include a PDU session request message. In an embodiment, second PDU session request message may include the fourth information. In an embodiment, the description of the traffic flow associated with the sidelink may include any of a PFI, a QoS rule and a packet filter. In an embodiment, the network element of the core network may be, or may include, an AMF.

In an embodiment, the first identifier may include any of an application layer identifier and a layer-2 identifier associated to the first WTRU in connection with a sidelink. In an embodiment, the second identifier may include any of an application layer identifier and a layer-2 identifier associated to the second WTRU in connection with a sidelink.

10A In an embodiment, the first PDU session may be based on any of a first application layer identifier and a first layer-2 identifier associated to the first WTRU in connection with a sidelink. In an embodiment, the second PDU session ID may be based on any of a second application layer identifier and a second layer-2 identifier associated to the second WTRU in connection with a sidelink.

In an embodiment, the first information may be transmitted as, or in, in a notification message. In an embodiment, the first information may be transmitted as, or in, any of a non-access stratum, NAS, message and a radio resource control, RRC, message.

In an embodiment, any of the second information and the third information may include any of network slice information and a DNN. In an embodiment, the first information may include a state of a sidelink between the first WTRU and a second WTRU. In an embodiment, the state of a sidelink may be a first of one or more values. The first value may indicates the sidelink is not, no longer or not likely to remain viable for communications with the second WTRU.

Among the procedures, methods, architectures, apparatuses, systems, devices, and computer program products is a third method that may be implemented in a WTRU and that may include any of: determining or predicting a network connectivity path change event for the WTRU within a residential network; transmitting an notification report to a core network, the notification report may include information disclosing a type of the path change and context information parameters regarding service characteristics prior to the path change; receiving a response to the notification report from the network configuring the WTRU for a path switch; and performing a path switch according to the response. In an embodiment, the WTRU may be operating in the residential network, which may be connected to the core network via a gateway associated with a premises.

In an embodiment, transmitting may include transmitting the notification report within a non-access stratum (NAS) message container of a service request message.

In an embodiment, the notification report may include any one or more of quality of service (QoS) flow identifiers, active link identifiers, application layer identifiers, a QoS profile for a new protocol data unit (PDU) session. In an embodiment, the notification report may include any one of more of a PC5 keep alive time out indicator, active PC5 link identifiers, gateway (e.g., 5G-RG) identification information, local (e.g., 5G-RG) SMF identification information, local (e.g., 5G-RG) UPF identification information, residential base station identifiers, WTRU location-related information, and single network slice selection assistance information (S-NSSAI).

In an embodiment, the response to the notification report may be a PDU session establishment accept message. In an embodiment, the method may include releasing the previous path resources.

Among the procedures, methods, architectures, apparatuses, systems, devices, and computer program products is a fourth method that may be implemented in a first WTRU and that may include any of: determining a state of a sidelink (“sidelink state”) between the first WTRU and a second WTRU; transmitting first information, indicating the sidelink state and first and second identifiers associated with the first and second WTRUs, to a first network element of a CN from which at least the first and second identifiers are conveyed to an application server; receiving, from a second network element of the core network, information to trigger the WTRU to request to establish or modify a PDU session; transmitting, to the second network element, second information indicating a description of a traffic flow (“traffic-flow description”) associated with the sidelink and a request to establish or modify the PDU session; transmitting outbound traffic of the traffic flow and an address of the first WTRU to the application server pursuant to the PDU session; and receiving inbound traffic of the traffic flow from the application server pursuant to the PDU session. In various embodiments, the first network element may comprise an AMY, and the second network element may comprise an SMF.

Among the procedures, methods, architectures, apparatuses, systems, devices, and computer program products is a fifth method that may be implemented in a first WTRU and that may include any of: determining a sidelink state of a sidelink between the first WTRU and a second WTRU; transmitting first information, indicating the sidelink state and first and second identifiers associated with the first and second WTRUs, to a network element of a core network from which at least the first and second identifiers are conveyed to an application server; transmitting, to the network element, second information indicating a traffic-flow description associated with the sidelink and a request to establish or modify a PDU session; transmitting outbound traffic of the traffic flow and an address of the first WTRU to the application server pursuant to the PDU session; and receiving inbound traffic of the traffic flow from the application server pursuant to the PDU session. In various embodiments, the network element may comprise an SMF.

Among the procedures, methods, architectures, apparatuses, systems, devices, and computer program products is a sixth method that may be implemented in a first WTRU and that may include any of: determining a sidelink state of a sidelink between the first WTRU and a second WTRU; transmitting first information, indicating the sidelink state, a traffic-flow description associated with the sidelink and first and second identifiers associated to the first and second WTRUs, to a network element of a core network from which at least the traffic-flow description and the first and second identifiers are conveyed to an application server; transmitting outbound traffic of the traffic flow and an address of the first WTRU to the application server pursuant to a PDU session; and receiving inbound traffic of the traffic flow from the application server pursuant to the PDU session. In various embodiments, the sixth method may include transmitting second information indicating a request to establish the PDU session on condition that the first WTRU is not in a connected mode.

Among the procedures, methods, architectures, apparatuses, systems, devices, and computer program products is a seventh method that may be implemented in a first WTRU and that may include any of: determining a sidelink state of a sidelink between the first WTRU and a second WTRU; transmitting first information, indicating the sidelink state, a traffic-flow description associated with the sidelink and first and second identifiers associated with the first and second WTRUs, to a first network element of a core network from which at least the traffic-flow description and the first and second identifiers are conveyed to an application server; receiving, from the first network element or a second network element of the core network, information to trigger a request to establish or modify a PDU session; transmitting second information indicating a request to establish or modify a PDU session; transmitting outbound traffic of the traffic flow and an address of the first WTRU to the application server pursuant to the PDU session; and receiving inbound traffic of the traffic flow from the application server pursuant to the PDU session.

In various embodiments of any of the fourth, fifth, sixth and seventh methods, determining the sidelink state may include any of: monitoring for keep alive transmissions; and determining the sidelink state based on a number of keep alive transmissions received within a time period. In various embodiments, the sidelink state may be (i) a first value if the number of keep alive transmissions received within the time period fails to satisfy a first threshold, and (ii) a second value if the number of keep alive transmissions received within the time period satisfies a second threshold. In various embodiments, the first and second thresholds may be the same threshold. In various embodiments, the first value may indicate the sidelink is not, no longer or might not remain viable for communications with the second WTRU.

In various embodiments, any of the fourth, fifth, sixth and seventh methods may include any of receiving an address of the second WTRU from the application server; and transmitting outbound traffic of the traffic flow using the address of the second WTRU.

Among the procedures, methods, architectures, apparatuses, systems, devices, and computer program products is a eighth method that may be implemented in an application server and that may include any of: receiving, from one or more network elements of one or more core networks, (i) first information indicating a first sidelink state of a sidelink between a first WTRU, and a second WTRU, a traffic-flow description of a traffic flow associated with the sidelink and first and second identifiers associated with the first and second WTRUs, wherein the first information originated from the first WTRU; and (ii) second information indicating a second sidelink state of the sidelink, the traffic-flow description and third and fourth identifiers associated to the first and second WTRUs, wherein the second information originated from the second WTRU; receiving, from the first WTRU, first traffic of the traffic flow and an address of the first WTRU; receiving, from the second WTRU, second traffic of the traffic flow and an address of the second WTRU; transmitting the second traffic using the first address; and transmitting the first traffic using the second address.

In various embodiments, receiving the first and second information from the network elements of the core networks may include any of (i) receiving the first information from a first network element of the network elements pursuant to a first subscription with the first network element to receive the first information responsive to a first event; and (ii) receiving the second information from a second network element of the network elements pursuant to a second subscription with the second network element to receive the second information responsive to a second event. In various embodiments, the first event may be when the first state indicates the sidelink is not, no longer or might not remain viable for communications with the second WTRU, and the second event may be when the second state indicates the sidelink is not, no longer viable or might not remain for communications with the second WTRU.

In various embodiments, the eighth method may include any of: obtaining the first subscription from the first network element; and obtaining the second subscription from the second network element. In various embodiments, the fifth method may include any of: transmitting the second address of the second WTRU to the first WTRU; and transmitting the first address of the first WTRU to the second WTRU.

In various embodiments, the eighth method may include any of: transmitting to the first network element or to a third of the network elements, third information to trigger establishment a third PDU session or modification of the a first PDU session; and transmitting to the second network element or to a fourth of the network elements, fourth information to trigger establishment of a fourth PDU session or modification of the second PDU session.

In various embodiments of the fifth method, the network elements may include any of: a first AMF associated with the first WTRU, a second AMF associated with the second WTRU, and an S1VIF associated with the first and second WTRUs.

In various embodiments of any of the fourth, fifth, sixth, seventh and eighth methods, the first identifier may include any of an application layer identifier of the first WTRU and a layer-2 identifier of first the WTRU, and the second identifier may include any of an application layer identifier of the second WTRU and a layer-2 identifier of the second WTRU. In various embodiments of the eighth method, the third identifier may include any of an application layer identifier of the first WTRU and a layer-2 identifier of first the WTRU, and the fourth identifier may include any of an application layer identifier of the second WTRU and a layer-2 identifier of the second WTRU.

In various embodiments of any of the fourth, fifth, sixth, seventh and eighth methods, the traffic-flow description may include any of a PFI and one or more QoS rules.

In various embodiments of any of the fourth, fifth, sixth, seventh and eighth methods, the first information may be transmitted as, or in, in a notification message. In various embodiments of the fifth method, the second information may be transmitted as, or in, in a notification message.

In various embodiments of any of the fourth, fifth, sixth, seventh and eighth methods, the first information is transmitted as, or in, any of an NAS message and an RRC message. In various embodiments of the eighth method, the second information is transmitted as, or in, any of an NAS message and an RRC message.

In various embodiments of the eighth method, the first sidelink state may be (i) a first value if the number of keep alive transmissions received within the time period fails to satisfy a first threshold, and (ii) a second value if the number of keep alive transmissions received within the time period satisfies a second threshold. In various embodiments, the first and second thresholds may be the same threshold.

In various embodiments of the eighth method, the second sidelink state may be (i) the first value if the number of keep alive transmissions received within the time period fails to satisfy a third threshold, and (ii) a fourth value if the number of keep alive transmissions received within the time period satisfies a fourth threshold. In various embodiments, the third and fourth threshold may be the same threshold. In various embodiments, the first, second, third and fourth thresholds may be the same threshold. In various embodiments, the first threshold may be the same as the third threshold, and the second threshold may be the same as the fourth threshold.

In various embodiments of the fourth, fifth, sixth, seventh and/or eighth methods, the first identifier, the second identifier, the third identifier, the fourth identifier and the PFIs may be included in a link profile identified by a PC5 link identifier.

Included among the procedures, methods, architectures, apparatuses, systems, devices, and computer program products is a ninth method that may be implemented in a WTRU and that may include generating a PC5 notification report based on PC5 inviability information associated with a PC5 sidelink, wherein the PC5 notification report may include one or more identifiers associated with the PC5 sidelink (“sidelink identifiers”), such as, e.g., one or more of the identifiers included in a link profile identified by a PC5 link identifier; invoking an entity of a communications protocol stack to convey the PC5 notification report to a network element; sending the PC5 notification report to the network element in a message according to a protocol of the entity of the communications protocol stack; on condition that the WTRU is not in a connected connection management state: transitioning to the connected management state and initiating a protocol data unit (PDU) session establishment request including one or more QoS rules/packet filter sets associated with the one or more sidelink identifiers, such as, for example, one or more of the QoS rules/packet filter sets included in a link profile identified by the PC5 link identifier; on condition that the WTRU is in the connected connection management state, initiating a PDU session modification request including the one or more QoS rules/packet filter sets associated with the one or more sidelink identifiers; and transmitting packets to an application server using a PDU session established in response to the PDU session establishment request or a PDU session as modified in response to the PDU session modification request. In an embodiment, the method may further include determining whether the PC5 sidelink is not, is no longer or might not remain viable for communications with another WTRU; and providing, to a sidelink event exposure function (SL-EEF), information indicating the PC5 sidelink interface is not, is no longer or might not remain viable.

In an embodiment, the method may further include providing the one or more active PC5 link identifiers to a SL-EEF.

In an embodiment, the one or more sidelink identifiers may include any of an application layer identifier and a layer-2 identifier and a set of PFIs. In an embodiment, each PFI may be associated with one or more QoS parameters.

In an embodiment, the PC5 notification report may be generated, and the entity of a communications protocol stack may be invoked by a SL-EEF. In an embodiment, the entity of a communications protocol stack may be any of a NAS and an RRC entity. In an embodiment, the protocol of the communications protocol may be any a NAS protocol and an RRC protocol.

In an embodiment, the message according to a protocol of the entity of the communications protocol stack may be a NAS Service Request message, and the PC5 notification report may be carried in a NAS message container of the NAS Service Request message.

In an embodiment, the message according to a protocol of the entity of the communications protocol stack may be a RRC MeasurementReport message, and the PC5 notification report may be carried in an information element (IE) of the RRC MeasurementReport message.

In an embodiment, the PDU session modification request may include one or more IEs configured to carry any of the QoS rules/packet filter sets and PFIs. In an embodiment, the PDU session establishment request may include one or more IEs configured to carry any of the QoS rules/packet filter sets and PFIs. In an embodiment, the IEs may include any of an extended protocol configuration options IE, a Requested QoS rules IE and Requested QoS flow descriptions IE.

In an embodiment, the method may further include receiving a mapping between the sidelink identifiers and one or more routable addresses on which to transmit the packets.

Included among the procedures, methods, architectures, apparatuses, systems, devices, and computer program products is a method that may be implemented in a network element and that may include receiving a PC5 notification report in a message according to a protocol of an entity of the communications protocol stack, wherein the PC5 notification report includes one or more sidelink identifiers associated with a PC5 sidelink of a WTRU; on condition that the WTRU is not in a connected connection management state: receiving a PDU session establishment request including one or more QoS rules/packet filter sets associated with the sidelink identifiers; on condition that the WTRU is in the connected connection management state, receiving a PDU session modification request including the QoS rules/packet filter sets; and providing at least the QoS rules/packet filter sets associated with the sidelink identifiers to an application server.

In an embodiment, the sidelink identifiers may include any of an application layer identifier and a layer-2 identifier and a set of PFIs. In an embodiment, each PFI is associated with one or more QoS parameters.

In an embodiment, the entity of a communications protocol stack may be any of a NAS and an RRC entity. In an embodiment, the protocol of the communications protocol may be any a NAS protocol and an RRC protocol. In an embodiment, the message according to a protocol of the entity of the communications protocol stack may be a NAS Service Request message, and the PC5 notification report may be carried in a NAS message container of the NAS Service Request message.

In an embodiment, the message according to a protocol of the entity of the communications protocol stack may be a RRC MeasurementReport message, and the PC5 notification report may be carried in an IE of the RRC MeasurementReport message. In an embodiment, the PDU session modification request may include one or more liEs configured to carry any of the QoS rules/packet filter sets and PFIs. In an embodiment, the PDU session establishment request may include one or more IEs configured to carry any of the QoS rules/packet filter sets and PFIs. In an embodiment, the IEs may include any of an extended protocol configuration options IE, a Requested QoS rules IE and Requested QoS flow descriptions IE.

Among the procedures, methods, architectures, apparatuses, systems, devices, and computer program products is an apparatus, which may include any of a processor and memory, configured to perform any of the methods and embodiments thereof directed to improved service continuity provided herein. In various embodiment, the apparatus may be, may be configured as and/or may be configured with elements of a WTRU. In various embodiment, the apparatus may be, may be configured as and/or may be configured with elements of a network element. In various embodiment, the apparatus may be, may be configured as and/or may be configured with elements of an application server.

Among the procedures, methods, architectures, apparatuses, systems, devices, and computer program products is a system, which may include any of a processor and memory, configured to perform any of the methods and embodiments thereof directed to improved service continuity provided herein. Also among the procedures, methods, architectures, apparatuses, systems, devices, and computer program products is a tangible computer readable storage medium having stored thereon computer executable instructions for performing any of the methods and embodiments thereof directed to improved service continuity provided herein.

For convenience and simplicity of exposition, various embodiments are described in connection with service continuity between a PC5 interface and an Uu interface. Those skilled in the art will recognize that such teachings are applicable for service continuity in other situations, such as, in connection with movement of WTRUs across different PLMNs, NPNs (SNPNs or PNI-NPNs).

Improved mechanisms for service continuity between the PC5 interface and the Uu interface in connection with a likely occurrence of WTRUs not remaining within proximity/ProSe communication range of each other are provided. The service continuity mechanisms may be carried out according to the following.
1. Notification reporting: A WTRU 102a may generate a notification report and may send the notification report to a network element of a core network 115, such as an AMF 182, and/or the application server 189 (e.g., via one or more of the networks of the communications system 100). The generation and/or sending of the notification report may be triggered in response to a determination that the sidelink is not, no longer or might not remain viable for communications between the WTRU 102a and one or more of the WTRU 102b/c/d. The notification report may include contextual information regarding a unicast link, other information disclosed herein supra or infra, and/or the like. The contextual information may include a PC5 link profile associated to the PC5 unicast link and a state of the PC5 layer-2 link, e.g., application layer identifiers and PFI(s).
2. Migration of some or all of existing PC5 flows to new and/or existing PDU sessions: The WTRU 102a may request migration of existing PC5 flows to a new PDU session using a WTRU requested PDU session establishment request. The WTRU 102a may request migration of existing PC5 flows to an existing PDU session using a WTRU requested PDU session modification request. The WTRU requested PDU session establishment request and/or the WTRU requested PDU session modification request may include QoS rules (packet filter sets) associated with the sidelink identifier(s).
3. Route packets based on a mapping between the PC5 interface and the Uu interface. Any of the ProSe application server and one or more network elements (e.g., the AMF 182, a local SMF, etc.) may construct a mapping between the unicast link profiles attributes (derived from the notification report) and routable destination addresses of the WTRUs (derived from the establishment or modification of PDU sessions). Any of the ProSe application server and the network elements may subsequently forward ProSe packets to the WTRUs using the constructed mapping table. Alternatively, and/or additionally, any of the ProSe application server and the network elements may provide (e.g., send) the constructed mapping table to the WTRUs so that subsequent ProSe packets may be addressed using routable destination addresses.

For convenience and simplicity of exposition, the mechanisms are described in connection with service continuity for two WTRUs and for various connection management states. Those skilled in the art will recognize that the same mechanisms are applicable to more than two WTRUs and/or to other connection management states.

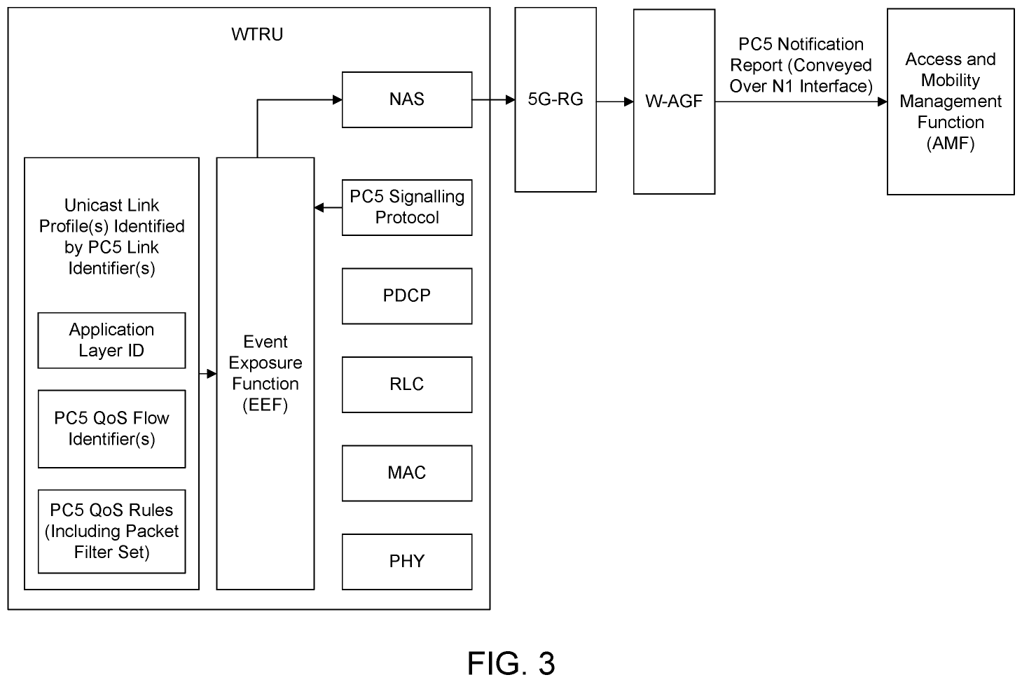

FIG. 3 is a block diagram illustrating an example architecture of a WTRU (“WTRU architecture”) 300 according to an embodiment. The WTRU architecture 300 may be suitable for generating a notification report and/or conveying a notification report to an AMF, such as AMF 182 (FIG. 1). The WTRU architecture 300 may include a link profile 310, a PC5 signaling protocol stack 312, a sidelink event exposure function (SL-EEF) 314 and a NAS entity 316. The PC5 signaling protocol stack 312 may include a PC5 signaling protocol entity 312a, a PDCP entity 312b, an RLC entity 312c, a MAC entity 312d and a PHY entity 312e.

Keep alive functionality of the PC5 signaling protocol entity may be used to determine whether the PC5 sidelink is or remains (or, conversely, is not, is no longer or might not remain) viable for communications with a neighboring WTRU (not shown in FIG. 3). If the PC5 sidelink is determined not to be, no longer or (likely) not to remain viable for communications (e.g., due to timeout), information indicating the PC5 sidelink is not, is no longer or might not remain viable (e.g., a PC5 keep alive timeout message or indicator) may be provided to the SL-EEF 314. Functionality other than (or in lieu of) keep alive functionality may be used to determine whether the PC5 sidelink is or remains (or, conversely, is not, is no longer or might not remain) viable for communications with the neighboring WTRU. This other functionality might not be a function of the PC5 signaling protocol entity, but rather of another entity now shown, and/or may provide the information indicating the PC5 sidelink is not, is no longer or might not remain viable (“inviability information”) to SL-EEF 314. The inviability information may be provided to the SL-EEF 314 on any of a push or pull basis.

The SL-EEF 314 may obtain the inviability information from the PC5 signaling protocol or other entity. The SL-EEF 314 may obtain one or more sidelink identifiers from the link profile 310. The SL-EEF 314 may obtain and/or determine other information to include in the notification report, such as disclosed herein supra or infra. For example, The SL-EEF 314 may obtain and/or determine information on a type of change in situation (e.g., an ongoing or a predicted forthcoming change in situation) and additional context information parameters regarding service characteristics prior to the path switching via the premises network. The context information parameters may include parameters such as QoS flow IDs (information), active link identifiers, application layer IDs, which may be pertinent for transfer from the ongoing protocol data unit (PDU) session and the applicable QoS profile to a new PDU session via the gateway 117.

The SL-EEF 314 may generate a notification report using the inviability information and the sidelink identifiers. The SL-EEF 314, for example, may concatenate or otherwise combine the inviability information, the sidelink identifiers and/or the other information, and may include the combination in the notification report.

The SL-EEF 314 may provide the notification report to the NAS entity 316 for transmission to AMF 182. The NAS entity 316 may invoke the NAS protocol to convey the notification report to the AMF 182, e.g., using an N1 interface or via an element having an N1 interface. For example, the notification report may be conveyed to a gateway 117 having an N1 interface, and the gateway 117 may convey the notification report (e.g., relay, forward or otherwise transmit the notification report on behalf to the WTRU) to the AMF 182 using the N1 interface. Alternatively, the notification report may be conveyed, via a gateway 117, to a (R)AN 113 having an N1 interface, and the (R)AN 113 may convey the notification report (e.g., relay, forward or otherwise transmit the notification report on behalf to the WTRU) to the AMF 182 using the N1 interface. Alternatively, the notification report may be conveyed, via a gateway 117, to a N3IFW/TNGF 119 having an N1 interface, and the N3IFW/TNGF 119 may convey the notification report (e.g., relay, forward or otherwise transmit the notification report on behalf to the WTRU) to the AMF 182 using the N1 interface.

### Premises Environments

Use cases and traffic scenarios in premises environments (e.g., residences, offices, campuses, etc.) and the related new potential functional requirements and potential key performance requirements are a focus of 5G 3GPP contribution [S1-203055] (TSA WG1 Meeting #91, August 2020], which is incorporated herein fully by reference.

Some of the challenges presented by 5G deployment in a premises environment, as outlined in 3GPP [S1-203056], incorporated herein fully by reference include high bitrate demand due to the prevalence of video/TV services and AR/VR gaming. Residential users commonly demand high bitrates and capacities. A need for high bitrates and high capacity can be addressed by the use of millimeter (mm) wave frequencies. However, use of such short wavelengths makes it difficult to provide outdoor-to-indoor coverage with operator base stations. In fact, at mm wave frequencies it is often difficult to provide adequate coverage indoors through internal walls and other obstacles. It may be necessary to provide a small base station in every room (e.g., integrated into a light fixture in the center of the ceiling) to provide adequate wireless coverage.

With fixed broadband services, the network operator may provide Internet access to a gateway that interfaces with one or more premises BSs that may provide wireless connectivity to wireless devices in the premises (telephones, televisions, computers, tablets, gaming systems, wireless printers, appliances, etc.). The gateway may be incorporated into a local area network (LAN) comprising dozens of devices (e.g., WTRUs). However, those individual devices on that LAN are not known or identifiable in the core network. For an integrated fixed broadband/mobile premises 5G offering, it would be beneficial for the core network to have knowledge of the identities of the devices behind the gateway.

Some use cases have been contributed to 3GPP recently, such as references [S1-203076], [S1-203077], [S1-203125], [S1-203151], [S1-203153], all of which are incorporated fully herein by reference. In all those use cases, the following assumptions are made regarding the 5G nodes and devices deployed in the residential environment:
5G Residential Gateway (5G-RG): A gateway that may be connected to the 5GC.
Premises base stations: These base stations may be connected via the gateway to the same 5GC that the gateway is connected to.
A plurality of the premises base stations may be deployed in different rooms and may be connected to the gateway either wirelessly and/or wired.
Each premises base station may serve one or more WTRUs in its coverage area.
A WTRU that is outdoors but in the coverage area of an premised base station may be (e.g., preferably) connected to the premises base station.
Multiple RATs (3GPP and non-3GPP) are available or could be available in the premises.

Two specific use cases of interest are (1) seamless switching from a direct communication between/among a plurality of WTRUs to an indirect communication via a gateway and (2) seamless switching to a service hosting environment via a gateway.

U.S. Provisional Patent Application No. 62/967,505, filed 29-Jan-2020, addresses issues of service continuity for applications running over a PC5 communication path (direct communication) in the event of the WTRUs moving out of the proximity range of each other, and is relevant to similar issues in the premises environment discussed herein, and is incorporated herein fully by reference. Two exemplary use cases that help illustrate some of the issues surrounding service continuity in a premises environment are considered below.

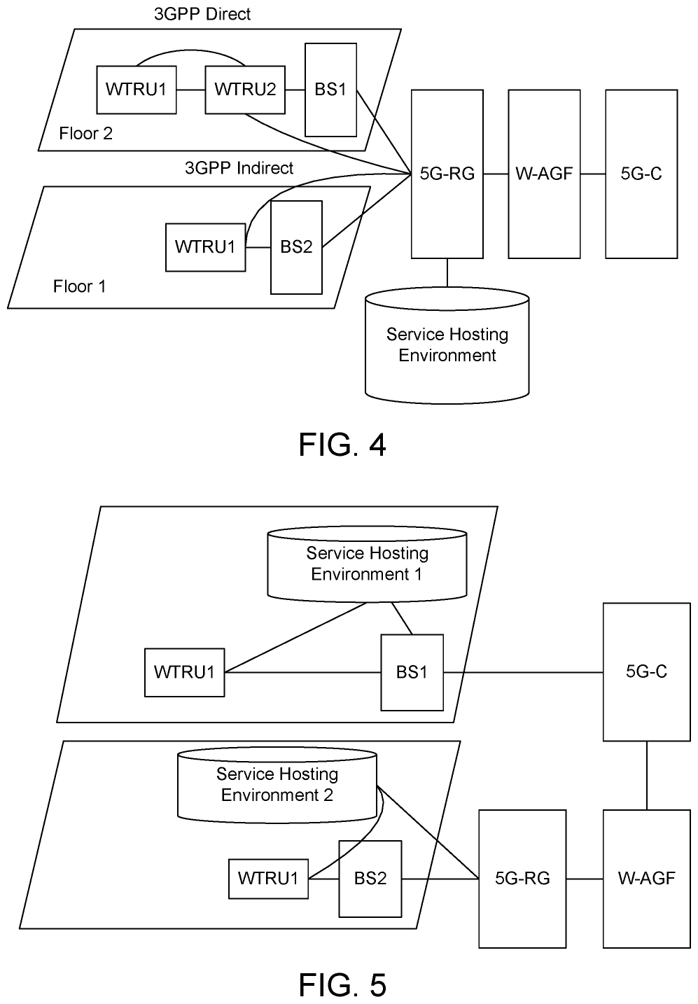

FIGS. 4 and 5 are block diagrams illustrating first and second mobility/connectivity switching scenarios and/or use cases. FIG. 4, for example, illustrates components of a WTRU as well as network nodes involved in a connectivity switching event. FIG. 5, for example, illustrates elements of a transfer of a direct session to an indirect session managed via a local SMF and a local UPF configured in a gateway in accordance.

For convenience and simplicity of exposition, the first and second mobility/connectivity switching scenarios/use cases are described with reference to the WTRU architecture 300 (FIG. 3), the PC5 unicast links (FIG. 2D) and the architecture of the communications system 100 (FIG. 1).

Further, as one of ordinary skill would recognize, some of the operations disclosed in connection with the first mobility/connectivity switching scenario/use case may be separately carried out by both of the two WTRUs. And as such, for convenience and simplicity of exposition in the description that follows, the nomenclature “WTRU 102a (WTRU 102b)” and “WTRU 102b (WTRU 102a)” is used to reflect the separate performance by the WTRUs. Also for convenience and simplicity of exposition in the description that follows, the nomenclature “WTRU 102a” refers to one of the two WTRUs and the nomenclature “WTRU 102b” refers to the other WTRU.

The first use case concerns seamless switching from a direct connectivity (e.g., a device-to-device (D2D) connection) between two WTRUs 102a, 102b to connectivity between the two WTRUs 102a, 102b via a network path using a gateway 117. The second use case concerns seamless switching to a service hosting environment via a gateway 117.

In the first use case (FIG. 4), two WTRUs 102a, 102b in direct communication may switch seamlessly to an indirect communication using via the gateway 117 due to mobility of one or both of the two WTRUs 102a, 102b that may result in the sidelink for the direct communication not or no longer being viable for the direct communications. As an example, initially in the first use case, the WTRU 102a (e.g., a smartphone or tablet) and the WTRU 102b (e.g., a laptop) may be on the same floor in a premises (e.g., a residence, an office, a campus building, etc.) and may be connected to each other via direct communication, wherein the WTRU 102a (WTRU 102b) may be receiving a direct service from the WTRU 102b (WTRU 102a). A specific quality of service (QoS) profile may be associated to the service. The WTRU 102a (WTRU 102b) may move to another floor while the service with the WTRU 102b (WTRU 102a) with the same specific QoS profile is ongoing. At some point in time after the move to the other floor, the sidelink for the direct communication is determined not to be, no longer, or (unlikely) not to remain viable for the direct communications e.g., a time out occurs). After such a determination is made by the WTRU 102a, the WTRU 102a may connect (e.g., automatically connect) to a first premises BS 114a. After the determination by the WTRU 102b, the WTRU 102b may connect (e.g., automatically connect) to a second premises BS 114b. The service may be maintained with the same QoS profile via the gateway 117 connecting the first premises BS 114a and the second premises BS 114b.

In the second use case (FIG. 5), a WTRU 102 may be consuming a low latency service (e.g., gaming) and may maintain the service with the same QoS settings as the WTRU moves from a first service hosting environment to a second service hosting environment, e.g., where both service hosting environments are served by the same 5GC. Initially, the WTRU 102 may consume the low latency service provided by the first service hosting environment through a public network. A specific QoS profile may be associated to this low latency service. After the WTRU 102 moves to a premises network, it may maintain its low latency service with the same specific QoS profile through an automatic transfer to the second service hosting environment provided to the WTRU seamlessly through a gateway 117.

In both of the first and second scenarios/use cases, there may be a need to detect a change of situation of a given WTRU (e.g., moving from direct communication to indirect communication in the first use case, and arriving into a residential environment in the second use case), notify this change to the gateway 117 and ensure that the gateway has (e.g., all necessary) information available to it (e.g., in a timely manner) in order to efficiently re-route the data packets locally to the WTRU(s) 102.

Described herein are mechanisms to maintain service continuity in a premises environment through a gateway. The mechanisms are described hereinbelow in the context of the first use case. However, this is merely for convenience, and it will be understood that the same procedures may be applied in other use cases, including the second use case.

Upon detecting a change of situation, the WTRU the WTRU 102a (WTRU 102b) may compile information for preparing a notification report and may generate and may convey the notification report to the 5GC 115. The notification report may include information on a type of change in situation (e.g., an ongoing or a predicted forthcoming change in situation) and additional context information parameters regarding the service characteristics prior to the path switching via the premises network. These context information parameters may include parameters such as QoS flow IDs (information), active link identifiers, application layer IDs, which are pertinent for transfer from the ongoing protocol data unit (PDU) session and the applicable QoS profile to a new PDU session via the gateway 117.

The 5GC 115 may process the notification reports received from the WTRUs 102a, 102b, may identify the WTRUs 102a, 102b and the gateway 117 may decide upon path switching to the residential network, and may communicate the path switching configuration back to the WTRUs 102a, 102b and the gateway 117.

The service data path between the WTRUs 102a, 102b may be rerouted (e.g., automatically) via the local UPF 127 (or local UPF 133) based on configuration by the local SMF 125 (or the local SMF 131).

In an example of the first use case, two WTRUs 102a, 102b may be engaged in direct communication (e.g., over PC5) and may be in connection management state CM-IDLE and RRC_IDLE with no active PDU sessions towards a 5GC 115 via a gateway 117. It will be understood by those of skill in the related arts that variations of the embodiment apply in alternative scenarios where, for example, both or one of the WTRUs 102a, 102b is/are in CM- CONNECTED, RRC_CONNECTED, with active PDU Sessions, or in CM-CONNECTED, RRC_CONNECTED with no active PDU Sessions.

The WTRU 102a and/or the WTRU 102b may detect and/or predict a change in situation. The WTRU 102a and/or the WTRU 102b, for example, may determine that the PC5 sidelink is not, no longer or might not remain viable for communications with the other WTRU using keep alive or other functionality of the PC5 signaling protocol entity 312a (e.g., as a proxy for detecting that the WTRUs are not within proximity/ProSe communication range of each other). The WTRU 102a and/or The WTRU 102b may determine to provide information to the 5GC 115 in anticipation of path switching via the gateway 117. In an embodiment, the WTRU 102a (WTRU 102b), e.g., the SL-EEF 314 thereof, may compile information for preparing a notification report, which may be referred to as an event notification report or its acronym “ENR” and/or used, and/or used interchangably with the terms “event notification report” and/or its acronym “ENR”. The notification report may include any of various information disclosed herein supra and/or infra. In an embodiment, notification report may include information about the event (e.g., PC5 keep alive time out) and information on a current state of the service (e.g., active PC5 link identifiers). The notification report may also include information related to the gateway 117, the local SMF 125 (or the local SMF 131) and the local UPF 127 (or the local UPF 133) IDs to assist the AMF 182 to (a) more quickly identify the gateway 117 that will provide service continuity, (b) more quickly identify the S1VIF that will control the session management, (c) more quickly identify the UPF that will route the traffic, and/or (d) increase security resilience (e.g., by routing via the local UPF 127 of the gateway 117 rather than an external UPF, or selecting a local S1VIF 125 instance of the gateway 117 for session management rather than an external SMF, or preferring an external UPF and SMF to the local UPF and SMF instances in the 5G-RG). Additionally with respect to increased security, if the WTRU 102a (WTRU 102b) may add the IDs to the message transmitted to the AMF 182, by binding the IDs to the message, the AMF 182 may have one more source of information related to the IDs that can be used to compare against its records. If this verification of IDs is made, security resilience is increased by the AMF 182 by verifying that the UE is connected to the correct and already authenticated gateway 117. If the verification fails, a misconfiguration or an attempt to spoof the gateway 117 may be occurring.

In an embodiment, information related to BS IDs also may be added to make the data path switching process faster. The notification report may include (may also include) WTRU location-related information to assist the AMF 182 in case communications with a location management function (LMF) is required. Network slice information such as, the single network slice selection assistance information (S-NSSAI) or QoS information also may be included in the report so the WTRUs can communicate under the same slice rules, if applicable.

The WTRU 102a (WTRU 102b) may convey the notification report to the AMF 182 via the gateway 117, via the gateway 117 and a (R)AN 113 (e.g., W-AGF), or via the gateway 117 and the N3IWF/TNGF. This may be done by invoking the non-access stratum (NAS) protocol to convey the notification report to the AMF 182 using the N1 interface (e.g., as disclosed herein in connection with FIG. 3).

After processing the notification reports, the 5GC 115 (e.g., an element thereof) may identify the WTRUs 102a, 102b, gateway 117 and/or QoS specifics of the direct session between WTRUs 102a, 102b and may make a decision as to whether to allow the path switch via the gateway 117.

Pursuant to the procedures, methods, architectures, apparatuses, systems, devices, and computer program product herein, one or both of the WTRU 102a, 102b may request the AMF 182 to initiate service continuity through the gateway 117. The AMF 182 may be then responsible to determine whether to use the information included in the notification report and may activate different possibilities for the SMF, UPF and application server instances.

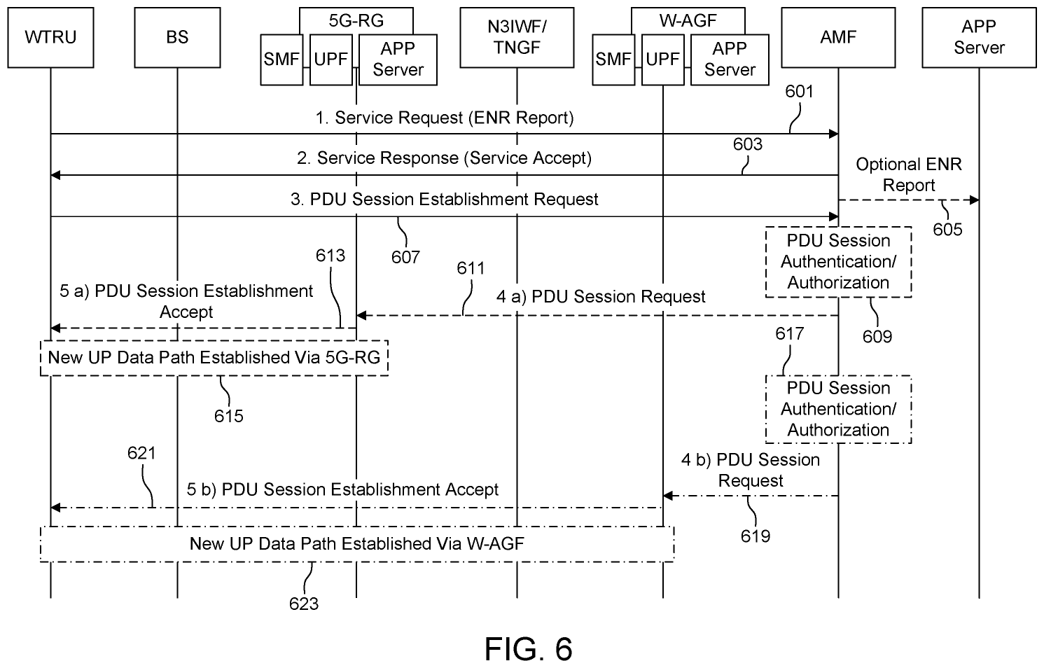

FIG. 6 is a diagram illustrating an example message exchange 600 in connection with carrying out service continuity according to various embodiments. The message exchange 600 may be suitable for use with, or in connection with (e.g., to support), carrying out service continuity in connection with two WTRUs engaged in sidelink transmission. For convenience and simplicity of exposition, the message exchange 600 is described with reference to the WTRU architecture 300 (FIG. 3), the PC5 unicast links (FIG. 2D) and the architecture of the communications system 100 (FIG. 1). The message exchange 600 may be carried out using different architectures as well.

Further, as one of ordinary skill would recognize, some of the message exchange 600 may be separately carried out by both of the two WTRUs. And as such, for convenience and simplicity of exposition in the description that follows, the nomenclature “WTRU 102a (WTRU 102b)” and “WTRU 102b (WTRU 102a)” is used to reflect the separate performance by the WTRUs. Also for convenience and simplicity of exposition in the description that follows, the nomenclature “WTRU 102a” refers to one of the two WTRUs and the nomenclature “WTRU 102b” refers to the other WTRU. The WTRU application layer (e.g., WTRU application 103) of the WTRU 102a may initiate a service that uses a PC5 unicast communication. The WTRU 102a may establish a secure layer-2 link over the PC5 interface with the WTRU 102b. In an embodiment, the WTRU 102a may send a direct communication request message to the WTRU 102b. The direct communication request message may be sent to trigger mutual authentication. The WTRU 102b may receive the direct communication request message and may initiate a procedure for mutual authentication. Successful completion of the mutual authentication procedure completes the establishment of the secure layer-2 link over PC5.

The WTRU 102a (WTRU 102b) may use the keep alive or other functionality of the PC5 signaling protocol entity 312a to maintain the layer-2 link over PC5. The WTRU 102a (WTRU 102b) may determine that the PC5 sidelink is not, no longer or might not remain viable for communications with the WTRU 102b (WTRU 102a) using the keep alive or other functionality of the PC5 signaling protocol entity 312a (e.g., as a proxy for detecting that the WTRUs are not within proximity/ProSe communication range of each other).

The SL-EEF 314 of the WTRU 102a (WTRU 102b) may generate a PC5 notification report using PC5 inviability information and the sidelink identifiers. The SL-EEF 314, for example, may concatenate or otherwise combine the PC5 inviability information and the sidelink identifiers to form the PC5 notification report.

Referring to FIG. 6, the WTRU 102a (WTRU 102b), while in CM-IDLE, may send the notification report to an AMF 182 in a NAS message container of the Service Request message (601). In an embodiment, the notification report may be carried in one or more Ies of the NAS message container, as a NAS message container contents IE (e.g., as depicted in an example NAS message container shown in FIG. 7.

Since the WTRU 102 may send the Service Request message while it is in CM-IDLE, the Ies thereof may be sent as non-cleartext Ies due to the Service Request message being an Initial NAS message. The WTRU 102 in CM IDLE state may use the service request procedure to request establishment of a secure connection to the AMF 182. Alternatively, the network (e.g., 5GC) may use the service request procedure to request the establishment of the secure connection among the WTRU 102, the AMF 182 and an application server 189. The service request procedure may be used by the WTRU 102 in CM-IDLE and/or in CM-CONNECTED to activate a user plane connection for an established PDU Session.

The AMF 182 may send a Service Accept message to the WTRU 102 (603) to acknowledge acceptance of the Service Request by the network. Alternatively, the AMF 182 may send a Service Reject message to the WTRU (not shown), e.g., if the Service Request cannot be accepted by network.

If the response to the Service Request message is a Service Reject message, then the WTRU 102a (WTRU 102b) may proceed to initiate the layer-2 link release over PC5 and conclude the PC5 service continuity procedure (note that this outcome is not illustrated in FIG. 6). Under those circumstances, the PC5 service continuity operation may be deemed unsuccessful. If the response to the Service Request message is a Service Accept message, the WTRU 102a (WTRU 102b) may transition from connection management state CM-IDLE to connection management state CM-CONNECTED via a premises base station 114a.

While in CM-CONNECTED state, the WTRU 102a (WTRU 102b) may initiate a PDU session establishment request (e.g., a UE Requested PDU Session Establishment Request) to the 5GC (607) and may include QoS rules/packet filters set(s) of the sidelink identifier(s).

The AMF 182 may have all information necessary to establish a new path for user plane (UP) data between WTRUs 102a, 102b, assuming it received notification reports from both WTRUs WTRU 102a, 102b. The AMF 182 may set a timer upon (e.g., determine an amount of time to elapse from) reception of one notification report from one of the WTRUs. At timer expiry (e.g., after the amount of time has elapse, the AMF 182 may proceed with the establishment of the PDU session and may inform the selected SMF that UP data is routed via the N6 interface. Alternatively, the AMF 182 may cancel the new PDU session.

Assuming notification reports are received from both WTRUs 102a, 102b, the AMF 182 may use PDU session ID (e.g., derived from the Layer 2 ID and Application ID), the S-NSSAI, and data network name (DNN) to establish the new connection between WTRUs (609 or 617 depending on the particular topology). In this case, the PDU session request sent to the SMF in the 5G-RG/W-AGF contains the information needed so that the SMF configures the local UPF to route packets between the two WTRUs.

Next, it notifies either the 5G-RG or the W-AGF (depending on the particular topology) with a PDU session request message (611 and 619, respectively). If the selected application server is located within the 5GC, the AMF sends the ENR report to the 5GC application server, as optionally shown at 605. If, on the other hand, the application server is located within the 5G-RG or W-AGF, this step would not be performed.

The WTRU 102a (WTRU 102b) may listen to the network for, and may receive, a response to the requested PDU session establishment request (607). The response may be, for example, a PDU session establishment accept message or a PDU session establishment reject message (or another like-type message). If the response to the requested PDU Session Establishment Request (607) is a PDU Session Establishment Reject message, then the WTRU 102a (WTRU 102b) may proceed to initiate the layer-2 link release over PC5 and may conclude the PC5 service continuity procedure (not shown in FIG. 6). Under these circumstances the PC5 service continuity operation may be deemed to be unsuccessful. Alternatively, if the response to the requested PDU session establishment request is a PDU Session Establishment Accept message (613 from the UPF of the gateway or 621 from the UPF of the W-AGF, respectively, depending on the chosen topology), the application layer of the WTRU 102a may send ProSe packets to the ProSe application server using the newly established PDU session (615 or 623, respectively, depending on the chosen topology). Although not specifically called out in FIG. 6, the WTRU 102a (WTRU 102b) may initiate a layer-2 link release over PC5 and may conclude the PC5 service continuity procedure. Under these circumstances the PC5 service continuity operation is deemed to be successful.

In various embodiments, a PDU Session Modification Request may be used instead of a PDU Session Establishment Request (e.g., if a PDU session has already be established). The PDU Session Establishment Request message and/or the PDU Session Modification Request message may include one or more IEs configured to carry any of the requested packet filters (QoS rules) and the requested QoS flow descriptions. The packet filters (QoS rules) associated the sidelink identifier(s) may be carried by the PDU Session Establishment(Modification) Request message in various ways (e.g., in various IEs of the message). For example, the packet filters (QoS rules) may be carried in an extended protocol configuration options IE of the PDU Session Establishment(Modification) Request message. Alternatively, the packet filters (QoS rules) may be carried in one or more other Ies (e.g., in extensions) of the PDU Session Establishment(Modification) Request message, such as in any of a “Requested QoS rules” IE and a “Requested QoS flow descriptions” IE.

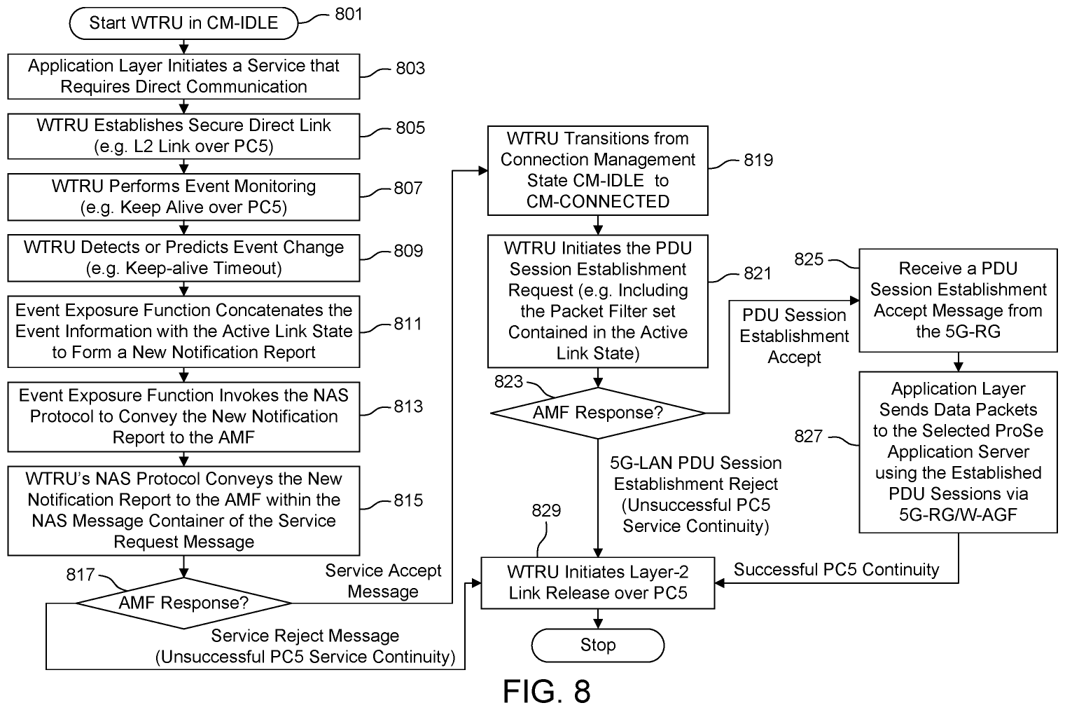

FIG. 8 is a flow chart illustrating an example flow 800 for carrying out service continuity according to various embodiments. The flow 800 may be suitable for carrying out service continuity in which two WTRUs engaged in sidelink transmission. For convenience and simplicity of exposition, the flow 800 is described with reference to the WTRU architecture 300 (FIG. 3), the PC5 unicast links (FIG. 2D) and the architecture of the communications system 100 (FIG. 1). The flow 800 may be carried out using different architectures as well.

At least some of the flow 800 may be performed by two WTRUs102a, 102b, e.g., in the case of the first scenario/use case depicted in FIG. 4 (or by a single WTRU 102 in the case of the second scenario/use case depicted in FIG. 5). Further, as one of ordinary skill would recognize, some of the flow 800 may be separately carried out by both of the two WTRUs. And as such, for convenience and simplicity of exposition in the description that follows, the nomenclature “WTRU 102a (WTRU 102b)” and “WTRU 102b (WTRU 102a)” is used to reflect the separate performance by the WTRUs. Also, for convenience and simplicity of exposition in the description that follows, the nomenclature “WTRU 102a” refers to one of the two WTRUs and the nomenclature “WTRU 102b” refers to the other WTRU.

The WTRU may be in CM-IDLE mode (801). The WTRU application layer (e.g., WTRU application 103) of the WTRU 102a may initiate a service that uses a PC5 unicast communication (803). The WTRU 102a may establish a secure layer-2 link over PC5 interface with the WTRU 102b (805). In an embodiment, the WTRU 102a may sends a direct communication request message to the WTRU 102b. The direct communication request message may be sent to trigger mutual authentication. The WTRU102b may receive the direct communication request message and may initiate a procedure for mutual authentication. Successful completion of the authentication procedure completes the establishment of the secure layer-2 link over PC5.

The WTRU 102a (WTRU 102b) may use the keep alive or other functionality of the PC5 Signaling Protocol entity 312a (807) to maintain the Layer-2 link over PC5. The WTRU 102a (WTRU 102b) may determine that the PC5 sidelink is not, no longer or might not remain viable for communications with the WTRU 102b (WTRU 102a) using the keep alive or other functionality of the PC5 signaling protocol entity 312a (e.g., as a proxy for detecting that the WTRUs are not within proximity/ProSe communication range of each other (809).

The SL-EEF 314 of the WTRU 102a (WTRU 102b) may generate a PC5 notification report using PC5 inviability information and the sidelink identifiers (811). The SL-EEF 314, for example, may concatenate or otherwise combine the PC5 inviability information, the sidelink identifiers and/or other information, e.g., as disclosed herein supra and infra and/or the like, and may include the combination in the notification report.

The SL-EEF 314 may provide the PC5 notification report to NAS entity 316 for transmission to AMF 182 (713). The NAS entity 216 may invoke the NAS protocol to convey the PC5 notification report to the AMF 182 using an N1 interface or via an element having an N1 interface. For example, the notification report may be conveyed to a gateway 117 having an N1 interface, and the gateway 117 may convey the notification report (e.g., relay, forward or otherwise transmit the notification report on behalf to the WTRU) to the AMF 182 using the N1 interface. Alternatively, the notification report may be conveyed, via a gateway 117, to a (R)AN 113 having an N1 interface, and the (R)AN 113 may convey the notification report (e.g., relay, forward or otherwise transmit the notification report on behalf to the WTRU) to the AMF 182 using the N1 interface. Alternatively, the notification report may be conveyed, via a gateway 117, to a N3IFW/TNGF 119 having an N1 interface, and the N3IFW/TNGF 119 may convey the notification report (e.g., relay, forward or otherwise transmit the notification report on behalf to the WTRU) to the AMF 182 using the N1 interface. The NAS entity may convey the PC5 notification report to the AMF 182 within the NAS message container of the Service Request message (815). Sending the NAS message to the network while the WTRU 102a (WTRU 102b) is in RRC IDLE mode may cause the WTRU 102a (WTRU 102b) to initiate an RRC connection (and enter RRC CONNECTED mode).

In the network (not shown in FIG. 8, which depicts only WTRU behavior), the AMF may (i) correlate information from the received notification report with information available at the AMF regarding the gateway and/or premises base stations to which the WTRUs potentially may be connected as well as the QoS service profile between these WTRUs, (ii) decide upon the alternative path for the WTRUs to route their traffic via the gateway, and (iii) send the configuration information to the WTRUs and the gateway, including information for instantiating a local UPF and/or a local SMF either at the gateway or at the W-AGF. The instantiation of the local UPF accounts (e.g., also accounts) for the scenario where the traffic may be routed through a local application server instantiated in the gateway or W-AGF.

The WTRU 102a (WTRU 102b) may listen for, and may receive, a response to the Service Request message from the AMF 182 (817). The response may be, for example, a Service Reject message or a Service Accept message (or another like-type message).

If the response to the Service Request message is a Service Reject message, then the WTRU 102a (WTRU 102b) may proceed to initiate the Layer-2 link release over PC5 (829) and may conclude the PC5 Service continuity procedure. Under these circumstances the PC5 service continuity operation is deemed to be unsuccessful. If the response to the Service Request message is a Service Accept message, then the WTRU 102a (WTRU 102b) may transitions from CM-IDLE to CM-CONNECTED via the premises base station (819). While in CM-CONNECTED state, the WTRU 102a (WTRU 102b) may initiate a PDU session establishment request to the 5GC and may include QoS rules/packet filters set(s) of the sidelink identifier(s) (821).

The WTRU 102a (WTRU 102b) (and the 5G-RG) may listen to the network for, and may receive, a response to the WTRU initiated PDU session establishment request (823). The response may be, for example, a PDU Session Establishment Accept message or a PDU Session Establishment Reject message (or another like-type message). If the response to the WTRU initiated PDU Session Establishment Request is a PDU Session Establishment Reject message, then the WTRU 102a (WTRU 102b) may proceed to initiate the Layer-2 link release over PC5 (829) and may conclude the PC5 service continuity procedure. Under these circumstances the PC5 service continuity operation may be deemed to be unsuccessful. If the response to the WTRU initiated PDU session establishment request is a PDU session establishment accept message, then the 5G-RG or the W-AGF may configure its local instances of UPF and SMF to manage the establishment of the new PDU sessions using tthe QoS flow information provided by the AMF. The local SMF 125/131 associated with the gateway or the W-AGF may send, the PDU session establishment accept message to the WTRU 102a (WTRU 102b), and the WTRU 102a (WTRU 102b) may receive the PDU session establishment accept message therefrom.

The application layer at the WTRU 102a may send ProSe packets to the selected ProSe application server via the gateway using the newly established PDU sessions (827). The WTRU 102a (WTRU 102b) may initiate a layer-2 link release over PC5 (829) and may conclude the PC5 service continuity procedure. Under these circumstances, the PC5 service continuity operation may be deemed to be successful.

In various embodiments, a PDU Session Modification Request may be used instead of a PDU Session Establishment Request (e.g., if a PDU session has already be established). The PDU Session Establishment Request message and/or a PDU Session Modification Request message may include one or more IEs configured to carry any of the requested packet filters (QoS rules) and the requested QoS flow descriptions. The packet filters (QoS rules) associated the sidelink identifier(s) may be carried by the PDU Session Establishment(Modification) Request message in various ways (e.g. in various IEs of the message). For example, the packet filters (QoS rules) may be carried in an extended protocol configuration options IE of the PDU Session Establishment(Modification) Request message. Alternatively, the packet filters (QoS rules) may be carried in one or more other IEs (e.g., in extensions) of the PDU Session Establishment(Modification) Request message, such as in any of a “Requested QoS rules” IE and a “Requested QoS flow descriptions” IE.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of” multiples of the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 25 U.S.C. § 112, ¶ 6 or means-plus-function claim format, and any claim without the terms “means for” is not so intended.

1. A method implemented in a network element of a core network of a communications system, the method comprising:
receiving, from one of first and second wireless transmit/receive units, WTRUs, via at least one gateway associated with a premises, one or more first transmissions comprising first information indicating first and second identifiers, IDs, associated to the first and second WTRUs in connection with a sidelink;
receiving, from the first WTRU via the at least one gateway, a second transmission comprising second information indicating a first request to establish a first protocol data unit, PDU, session, a first PDU session ID and a description of a traffic flow associated with the sidelink;
receiving, from the second WTRU via the at least one gateway, a third transmission comprising third information indicating a second request to establish a second PDU session, a second PDU session ID and the description of the traffic flow associated with the sidelink; and
transmitting a fourth transmission comprising fourth information indicating (i) an instruction to configure the at least one gateway with at least one session management function and (ii) to trigger the at least one session management function to establish the first and second PDU sessions via the at least one gateway based on/using the first and second PDU session IDs indicated by the second and third transmissions and the description of a traffic flow associated with the sidelink indicated by at least one of the second and third transmissions.

2. The method of claim 1, comprising:
determining to use the at least one session management function for the first and second PDU sessions based on at least one of the first request to establish the first PDU session and the second request to establish the second PDU session being received via the at least one gateway.

3. (canceled)

4. (canceled)

5. The method of claim 1, wherein the one or more first transmissions comprise a service request message, and wherein the service request message comprises the first information.

6. The method of claim 1, wherein the second transmission comprises a first PDU session establishment request message, and wherein the first PDU session establishment request message comprises the second information.

7. The method of claim 1, wherein the third transmission comprises a second PDU session establishment request message, and wherein the second PDU session establishment request message comprises the third information.

8. The method of claim 1, wherein the fourth transmission comprises a PDU session request message, and wherein the second PDU session request message comprises the fourth information.

9. The method of claim 1, wherein the description of the traffic flow associated with the sidelink comprises any of a PC5 QoS flow identifier (PFI), a QoS rule and a packet filter.

10. The method of claim 1, wherein the network element of the core network is an access and mobility management function (AMF).

11. The method of claim 1, wherein the first identifier comprises any of an application layer identifier and a layer-2 identifier associated to the first WTRU in connection with a sidelink, and wherein the second identifier comprises any of an application layer identifier and a layer-2 identifier associated to the second WTRU in connection with a sidelink.

12. The method of claim 1, wherein the first PDU session is associated with any of a first application layer identifier and a first layer-2 identifier associated to the first WTRU in connection with a sidelink, and wherein the second PDU session ID is associated with any of a second application layer identifier and a second layer-2 identifier associated to the second WTRU in connection with a sidelink.

13. The method of claim 1, wherein the first information is transmitted as, or in, in a notification message.

14. The method of claim 1, wherein the first information is transmitted as, or in, any of a non-access stratum, NAS, message and a radio resource control, RRC, message.

15. The method of claim 1, wherein any of the second information and the third information comprises any of network slice information and a data network name (DNN).

16. The method of claim 1, wherein the first information comprises a state of a sidelink between the first WTRU and a second WTRU.

17. The method of claim 16, wherein the state of a sidelink is a first value, and wherein the first value indicates the sidelink is not viable, no longer viable or not likely to remain viable for communications with the second WTRU.

18. (canceled)

19. A network element of a core network of a communications system, the network element comprising:
circuitry, including any of a transmitter, receiver, a processor and memory, the circuitry configured to
receive, from one of first and second wireless transmit/receive units, WTRUs, via at least one gateway associated with a premises, one or more first transmissions comprising first information indicating first and second identifiers, IDs, associated to the first and second WTRUs in connection with a sidelink,
receive, from the first WTRU via the at least one gateway, a second transmission comprising second information indicating a first request to establish a first protocol data unit, PDU, session, a first PDU session ID and a description of a traffic flow associated with the sidelink:
receive, from the second WTRU via the at least one gateway, a third transmission comprising third information indicating a second request to establish a second PDU session, a second PDU session ID and the description of the traffic flow associated with the sidelink, and
transmit a fourth transmission comprising fourth information indicating (i) an instruction to configure the at least one gateway with at least one session management function and (ii) to trigger the at least one session management function to establish the first and second PDU sessions via the at least one gateway based on/using the first and second PDU session IDs indicated by the second and third transmissions and the description of a traffic flow associated with the sidelink indicated by at least one of the second and third transmissions.

20. (canceled)

21. The network element of claim 19, the circuitry configured to:
determine to use the at least one session management function for the first and second PDU sessions based on at least one of the first request to establish the first PDU session and the second request to establish the second PDU session being received via the at least one gateway.

22. The network element of claim 19, wherein the one or more first transmissions comprise a service request message, and wherein the service request message comprises the first information.

23. The network element of claim 19, wherein the second transmission comprises a first PDU session establishment request message, and wherein the first PDU session establishment request message comprises the second information.

24. The network element of claim 19, wherein the third transmission comprises a second PDU session establishment request message, and wherein the second PDU session establishment request message comprises the third information.

25. The network element of claim 19, wherein the fourth transmission comprises a PDU session request message, and wherein the second PDU session request message comprises the fourth information.

26. The network element of claim 19, wherein the description of the traffic flow associated with the sidelink comprises any of a PC5 QoS flow identifier (PFI), a QoS rule and a packet filter.

27. The network element of claim 19, wherein the network element of the core network is an access and mobility management function (AMF).

28. The network element of claim 19, wherein the first identifier comprises any of an application layer identifier and a layer-2 identifier associated to the first WTRU in connection with a sidelink, and wherein the second identifier comprises any of an application layer identifier and a layer-2 identifier associated to the second WTRU in connection with a sidelink.

29. The network element of claim 19, wherein the first PDU session is associated with any of a first application layer identifier and a first layer-2 identifier associated to the first WTRU in connection with a sidelink, and wherein the second PDU session ID is associated with any of a second application layer identifier and a second layer-2 identifier associated to the second WTRU in connection with a sidelink.

30. The network element of claim 19, wherein the first information is transmitted as, or in, in a notification message.

31. The network element of claim 19, wherein the first information is transmitted as, or in, any of a non-access stratum, NAS, message and a radio resource control, RRC, message.

32. The network element of claim 19, wherein any of the second information and the third information comprises any of network slice information and a data network name (DNN).

33. The network element of claim 19, wherein the first information comprises a state of a sidelink between the first WTRU and a second WTRU.

34. The network element of claim 33, wherein the state of a sidelink is a first value, and wherein the first value indicates the sidelink is not viable, no longer viable or not likely to remain viable for communications with the second WTRU.
